(19) United States
(12) Patent Application Publication
(10) Pub. No.: US 2026/0336903 A1
(43) Pub. Date: Oct. 29, 2026

(54) PHOTO-CATALYTIC ANTIMICROBIAL PACKAGING FILMS

(71) Applicant: VIRGINIA TECH INTELLECTUAL PROPERTIES, INC., Blacksburg, VA (US)

(72) Inventors: Haibo HUANG, Christiansburg, VA (US); Danmeng SHUAI, Herndon, VA (US); Young KIM, Blacksburg, VA (US); Jian WU, Blacksburg, VA (US); Andrea JOHNSON, Elliston, VA (US)

(21) Appl. No.: 18/880,908

(22) PCT Filed: Jul. 5, 2023
(86) PCT No.: PCT/US23/26960

§ 371 Date: Jan. 3, 2025

Related U.S. Application Data
(60) Provisional application No. 63/358,322, filed on Jul. 5, 2022.

(51) Int. Cl. B65D 81/28; C08K 5/3415; C08K 9/02

(52) U.S. Cl. CPC B65D 81/28; C08K 5/3415; C08K 9/02

(57) ABSTRACT

A food packaging composition comprising a thermoplastic polymer, TiO₂ and a dye are described. A food packaging comprising the composition is described. Methods of improving the shelf life of a packaged food product are described.

### CROSS-REFERENCE TO RELATED APPLICATIONS

This application claims priority to, and the benefit of, co-pending U.S. provisional application entitled “PHOTO-CATALYTIC ANTIMICROBIAL PACKAGING FILMS AND OTHER CONTACTING SURFACE,” having Ser. No. 63/358,322 filed Jul. 5, 2022, the contents of which are incorporated by reference herein.

### STATEMENT REGARDING FEDERALLY SPONSORED RESEARCH OR DEVELOPMENT

This invention was made with government support under award 2021-67017-33345, awarded by the United States Department of Agriculture—National Institute of Food and Agriculture (USDA-NIFA). The government has certain rights in the invention.

### TECHNICAL FIELD

The present disclosure generally relates to a composition for packaging a food product, and, to the preservation of a food product, and a shelf life increase of a packaged food product.

### BACKGROUND

Microbial contamination causes food spoilage and increases the risk of foodborne illnesses. Food packaging materials are crucial for safe food storage, handling, and transportation, and places an important role in extending the shelf-life of foods or food products. Antimicrobial packaging, a type of smart packaging, has drawn major interest because it could have a significant impact on food shelf-life extension and improve food safety. It incorporates antimicrobial agent(s) into the packaging film to suppress spoilage and pathogenic bacteria and provide high-quality and safe foods. Many types of antimicrobial packaging materials with different antimicrobial agents have been investigated during the past two decades. These antimicrobial agents include silver zeolites, organic acids, essential oils and other plant extracts, enzymes, peptides, and bacteriocin. However, these compounds often fail to provide a broad spectrum of antimicrobial activity or failed to retain high activity for an extended period when incorporated into polymeric films, making antimicrobial packaging a challenging technology.

Thus, there is an acute need to develop effective, broad-spectrum, cost-effective, and robust antimicrobial packaging materials to ensure food quality and safety.

### SUMMARY OF THE DISCLOSURE

In various aspects, the present disclosure provides a food packaging composition which includes a thermoplastic polymer, and a coordination complex which includes titanium dioxide (TiO2), and a dye. In one aspect, the disclosure relates to a food packaging which includes the food packaging composition. In various aspects, the disclosure relates to methods of preserving food products, or extending the shelf life, and/or usable life of a food product.

The compositions, packaging, and methods described in the present disclosure overcome many of the deficiencies with prior compositions, packaging, and methods of preservation of food products. For example, the compositions and packaging are not required to be physical contact with a food product, and the compositions and packaging need only be exposed to visible light to initiate food preservation.

In various aspects, the disclosure includes a packaging composition comprising a thermoplastic polymer and an effective amount of a coordination complex comprising TiO₂ and a porphyrin dye. The thermoplastic polymer may be a, e.g., polyolefin, polyester, and/or polycarbonate. The thermoplastic polymer may be generally biodegradable, e.g., a cellulose, or a cellulose derivative.

In various aspects, the disclosure includes a food packaging container that includes the packaging composition described above. The packaging container generally comprises a wall that is translucent or transparent to light from 100 to 1500 nm.

In various aspects, the disclosure includes a general method of preserving and/or increasing the shelf life of a food product that includes a method of preserving a food product comprising contacting the food product with the food composition described above or the food packaging container described above, exposing the composition and/or packaging to light having a wavelength of from about 100 nm to about 1500 nm.

Other systems, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a bar graph that shows the E. coli population in a cell culture in units of Log Colony-Forming Units (CFUs) (Log CFU) in both light and dark conditions after treatment with TiO₂, TcPP, or TiO₂—TcPP conjugate in 10% ethanol solution. Control experiments are also shown using 10% ethanol solution or sterile water.

FIG. 2 is a bar graph that shows the E. coli population in a cell culture in units of Log CFU for cell cultures treated with TcPP ethanol solution (10% ethanol) and a TcPP+TiO2 ethanol suspension (10% ethanol), at concentrations of 0.2, 0.5, and 1 mg/mL.

FIG. 3 is a graph of singlet oxygen concentration (mM) as a function of time (hours) upon irradiating water, a TiO₂ suspension in water, a TcPP solution in water, and a TiO₂—TcPP suspension in water.

FIG. 4 is a graph of hydrogen peroxide concentration (μM) as a function of time (hours) upon irradiating: water, a TiO₂ suspension in water, a TcPP solution in water, and a TiO₂—TcPP suspension in water

FIG. 5 is a bar graph that shows the E. coli population in a cell culture in units of Log CFU for cell cultures treated with a cellulose nanofiber film containing TcPP+TiO2 incorporated into the film at an equivalent concentrations of 0 mg/mL, 0.02 mg/mL, 0.04 mg/mL, 0.2 mg/mL, and 0.6 mg/mL under both darkened and irradiated conditions.

FIG. 6 is a bar graph showing the E. coli population in a cell culture in units of Log CFU for cell cultures treated with a cellulose nanofiber film with TcPP+TiO2 incorporated into the film at 2 mg TiO₂—TcPP coordination complex per square cm of film as a function of the light intensity (Lux).

FIG. 7 is a bar graph that shows the E. coli population on cucumber contacted with a cellulose nanofiber film with no incorporated TcPP+TiO2, with a cellulose nanofiber film with incorporated TcPP+TiO2, and with no film, and wherein the results indicate treatment in darkened and irradiated conditions.

FIG. 8 is a scanning electron microscope image of a cellulose nanofiber according to the description and an inset magnified portion of the image.

FIG. 9 is a scanning electron microscope image of a cellulose nanofiber with TcPP+TiO2 according to the description and an inset magnified portion of the image, showing the incorporation of TcPP+TiO2 in the packaging film.

FIG. 10 is a bar graph showing the E. coli population reduction in units of log CFU for various dyes alone and in combination with TiO₂ under both dark and irradiated (6000 lux) conditions.

FIG. 11 is a graph of Escherichia coli population in units of Log CFU as a function of incubation time (hours) when treated with blank cellulose nanofiber under darkened conditions, with blank cellulose nanofiber under irradiated conditions, with cellulose nanofiber containing TcPP+TiO₂ under darkened conditions, and with cellulose nanofiber containing TcPP+TiO₂ under irradiated conditions (3000 lux).

FIG. 12 is a graph of Leuconostoc lactis populations in units of Log CFU as a function of the incubation time (hours) when treated with blank cellulose nanofiber under darkened conditions, with blank cellulose nanofiber under irradiated conditions, with cellulose nanofiber containing TcPP+TiO2 under darkened conditions, and with cellulose nanofiber containing TcPP+TiO2 under irradiated conditions (3000 lux).

FIG. 13 is a graph of Pseudomonas fluorescens populations in units of Log CFU as a function of time (hours) when treated with blank cellulose nanofiber under darkened conditions, with blank cellulose nanofiber under irradiated conditions, with cellulose nanofiber containing TcPP+TiO2 under darkened conditions, and with cellulose nanofiber containing TcPP+TiO2 under irradiated conditions (3000 lux).

### DETAILED DESCRIPTION

Photocatalytic antimicrobial techniques using semiconductor metal oxides have recently shown great promise in improving food quality and safety. Studies have reported that photocatalytic metal oxides can inactivate a wide spectrum of bacteria under UV or visible light.^{2-5, 27} A variety of photocatalytic metal oxides have been investigated for their potential antimicrobial properties, including titanium dioxide (TiO₂), zinc oxide (ZnO), copper oxide (CuO), iron oxide (Fe₂O₃) and magnesium oxide (MgO). These photocatalytic metal oxides participate in light-catalyzed redox reactions owing to their unique electronic configurations (a filled valence band and an empty conduction band). Upon receiving a photon (hv) of a suitable energy from light irradiation, photocatalytic metal oxides produce electron (e)-hole (h) pairs on their surfaces. The electron (e)-hole (h) pairs can react with surface-bound molecules (e.g., O₂, H₂O, and others) to generate strong reactive oxygen species (ROS, ·OH, O₂^{_}; H₂O₂) in a series of chain reactions (88). The generated ROS can be effectively used to inactivate bacteria through different mechanisms, including the oxidation of intercellular coenzyme-A to disrupt bacterial metabolic pathways,²⁹ oxidative damage to cell membranes,” and oxidative reactions with nucleic acids.³⁰ These multiple inactivation pathways make it difficult for bacteria to develop resistance to ROS attacks.³¹ As a result, the photocatalytic technique can inactivate a wide range of bacteria and offers numerous applications in the antimicrobial product market.

Among all photocatalytic metal oxides, TiO₂ has been recognized as the most widely studied photocatalyst owing to its unique electronic configuration, photostability, chemical stability, low-cost, and non-toxicity.³² The FDA has approved the use of TiO₂ as an additive in human food, drugs, cosmetics, and food contact materials (FDA, 2014). Studies have been conducted to incorporate TiO₂ particles into packaging films to successfully inactivate spoilage and pathogenic bacteria to extend the shelf-life of foods and ensure food safety.²⁵ However, TiO₂ has a significant limitation because it is only responsive to UV light (λ<380 nm) due to its large bandgap of 3.0-3.2 eV.⁶ This prevents TiO₂'s widespread applicability in the food supply chain as an antimicrobial agent because UV light is not readily available in the majority of food storage and display scenarios. Recently, it was reported that the use of organic dyes to sensitize TiO₂ can be an effective way to expand the responsive light wavelength from the UV light to visible light regions. The conjugated dyes can absorb photons under visible light irradiation and is photoexcited from a ground state (D) to an excited state (D*), which results in the injection of an electron into the conduction band of the TiO₂. Thus, the excitation wavelength range of TiO₂ is extended and ROS can be generated under visible light irradiation. Dye sensitizers, as reported, can harness up to 50% of sunlight energy. This notable ability significantly amplifies the visible light photocatalytic activity of TiO₂ (Wang et al., 2006; Bian et al. 2023).

Despite the great potential of dye-sensitized photocatalytic packaging films, their effectiveness at inactivating microorganisms under visible light, and/or varying light intensities, especially for microorganisms in a real food matrix, remains unclear. It has been found that the bacteriostatic effect of a film, with various TCPP-TiO₂ loadings, and under different visible-light intensities, provides a solution to the above difficulties. Furthermore, there is commercial potential of the TCPP-TiO₂ nanocellulose film to inactivate bacteria within an actual food matrix, as shown utilizing a cucumber as a representative model.

In various aspects, the disclosure includes a packaging composition comprising a thermoplastic polymer and an effective amount of a coordination complex comprising TiO₂ and a porphyrin dye. The thermoplastic polymer may be a, e.g., polyolefin, polyester, and/or polycarbonate. The thermoplastic polymer may be generally biodegradable, e.g., a cellulose, or a cellulose derivative.

In various aspects, the disclosure includes a food packaging container that includes the packaging composition described above. The packaging container generally comprises a wall that is translucent or transparent to light from 100 to 1500 nm.

In various aspects, the disclosure includes a general method of preserving and/or increasing the shelf life of a food product that includes a method of preserving a food product comprising contacting the food product with the food composition described above or the food packaging container described above, exposing the composition and/or packaging to light having a wavelength of from about 100 nm to about 1500 nm.

Although any methods and materials similar or equivalent to those described herein can also be used in the practice or testing of the present disclosure, the preferred methods and materials are now described. Functions or constructions well-known in the art may not be described in detail for brevity and/or clarity. Aspects of the present disclosure will employ, unless otherwise indicated, techniques of organic chemistry, polymer chemistry, nanotechnology, material sciences, and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and the range less than ‘y’. The range can also be expressed as an upper limit e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some aspects, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

The disclosure has been organized with aide of various section headings, which are used for convenience and readability, and should not be construed in any way as limiting the disclosure or the scope of the claims. The claims may, in some instances, incorporate aspects that fall under different section headings and such combinations of aspects are understood to be encompassed by the instant disclosure.

The disclosure will be better understood with the aid of certain definitions and prescribed methods, which are described in detail in the sections entitled Definitions and Methods. Other terms and methods may be described elsewhere in the disclosure, including in the Examples, and yet others will be understood by those skilled in the art upon reading the disclosure provided herein. All definitions and methods described herein should be understood to control over dictionary definitions, definitions in documents incorporated by reference, and/or ordinary meanings of the defined terms.

### Food Packaging Compositions

A variety of food packaging compositions are provided that overcome the aforementioned deficiencies with packaging films incorporating TiO₂. The compositions can be used in a variety of food packaging containers and other food contacting surfaces where preservation of food products and/or the inhibition of spoilage microorganisms is desired. The packaging compositions a coordination complex described herein and a thermoplastic polymer matrix.

In various aspects, the packaging composition can be formed as a bulk product, e.g., wherein the thermoplastic polymer, the TiO₂ and the dye are fully and substantially, homogeneously admixed such that the packaging composition is an article. The packaging composition can be a melt-extrudable material containing a thermoplastic polymer, the TiO₂ and the dye.

The food packaging composition will include at least a thermoplastic polymer and the coordination complex described herein. The packaging composition can contain 1, 2, 3, 4, or 5 different dyes as described herein. Other additives commonly employed in the manufacture of food packaging containers can also be included. These additional additives can also be included to impart suitable processability, stability, mechanical properties, or aesthetic properties. The packaging composition can further contain at least one compound selected from the group consisting of plasticizers, antimicrobials, flame retardants, antistatic agents, blowing agents, colored pigments, and any combination thereof, all of which are compatible with the thermoplastic polymer, the TiO₂ and the dye.

The food packaging composition can be formulated into a variety of forms for downstream use such as pellets or granules, powders, flakes or chips, resins or resin sheets, films, or foils. Pellets and granules can provide a consistent and uniform feedstock for extrusion, injection molding, or other processing methods. Powders can be useful in instances where the downstream processing into containers will include blending with additional additives at the time of container manufacture. Resin sheets are commonly employed in thermoforming processes, where they are heated, softened, and shaped into desired packaging forms. Films can be used as packaging materials themselves or as starting materials for subsequent converting processes like laminating, printing, or pouch-making.

### Coordination Complexes

Coordination complexes described herein will include at least TiO₂ and a suitable dye capable of sensitizing the TiO₂. The term “coordination complex” and “conjugate” can be used interchangeably herein to refer to a complex having a TiO₂ particle and one or more dye associated covalently or noncovalently to the surface of the TiO₂ particle to sensitize the TiO2. It has been found that, by sensitizing the TiO₂ with a suitable dye with absorption in the visible spectrum can result in enhanced antimicrobial activity of the TiO₂ under light conditions relevant for packaged food products e.g., under ambient light conditions.

In some aspects, the dye is noncovalently associated with the TiO₂, for example through van der Waals forces, hydrogen bonding, or electrostatic interactions. The adsorption process can be enhanced by adjusting factors such as dye concentration, temperature, and mixing time.

In some aspects, the coordination complex can include the dye covalently associated to the surface of the TiO₂, for example through one or more dative bonds. In some aspects, the dative bond is to a polar group on the dye

The TiO₂ and the dye can be formulated as an additive for mixing or blending with a thermoplastic. Suitable additives are often in the form of powders or smaller particle blends. The TiO₂ and the dye can be formulated in a specific ratio to optimize properties such as efficacy, stability, or compatibility with chosen thermoplastics. In some aspects, a w/w ratio of TiO₂ to the dye is from 50:1 to 1:5. In some aspects, a w/w ratio of TiO₂ to the dye is from 10:1 to 1:10.

In some instances, the coordination complex can be represented by a compound of formula (II):

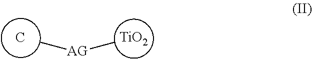

wherein C is a chromophore and AG is the anchoring group; or a salt thereof.

In certain aspects, the anchoring group AG can include a linker and the polar moiety. In certain aspects, the linker and the polar moiety are the same. For example, a carboxyl group bonded through the carbonyl carbon can be bonded to the chromophore; and the oxygens of the carboxyl group are the polar moiety which bond to the Titanium atom.

In certain aspects, the linker can be an alkyl group, an ether, an ester, an amide, an aromatic group, a heteroaromatic group, and the like. The linker can have from 1 to 3 carbon atoms.

In certain aspects, the TcPP-TiO₂ coordination complex (conjugate) can be represented by a compound of formula (IV):

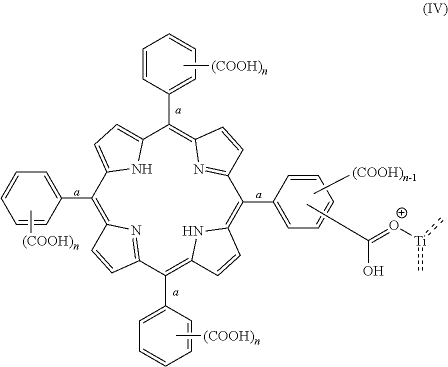

wherein n is 1; a is a bond; and each carboxyl group is para to a; or a salt thereof.

In an exemplary aspect, 1 mmol of TcPP is added to 96% ethanol and stirred until dissolved. Nanoparticles of TiO₂ are added to the TcPP solution and stirred in the dark at 75 °C at atmospheric pressure. The TcPP-TiO₂ coordination complex (conjugate) is isolated as a grey solid and added to water to form a 0.02% w/v solution in water.

### Titanium Dioxide

The titanium dioxide (TiO₂) may be of any crystal structure or form suitable to be useful in the packaging composition. The TiO₂ crystal structure may be an anatase or rutile crystal structure. The packaging composition may comprise one or more crystal structures or forms.

### Dyes

In certain aspects, the dye is a compound of formula (I):

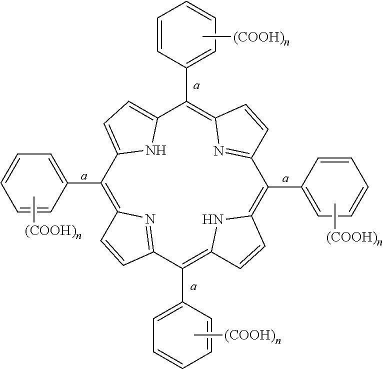

or a salt thereof; wherein n is 1 or 2, and a is a bond.

In certain aspects, when n is 1, each COOH group is para to the bond a. The compound of this structural formula may be known under IUPAC nomenclature as 4-[10,15,20-tris(4-carboxyphenyl)-21,24-dihydroporphyrin-5-yl]benzoic acid. The compound of this structural formula may also be known as tetrakis(4-carboxyphenyl)porphyrin, or “TcPP.”

In certain aspects, the compound of formula (I), when a salt, may be a monocarboxylate salt, a dicarboxylate salt, a tricarboxylate salt, or a tetracarboxylate salt. Alternatively, one or two of the nitrogens of the porphyrin ring may be mono or di-protonated.

In certain aspects when n is 2, each COOH group is meta to the bond a.

In certain aspects, the dye may be a metal complex of TcPP, for example, a metal complex selected from the group consisting of Cu—TcPP, Zn-TCPP, Fe-TcPP, and Ni-TcPP. Such complexes may include the neutral species, or a charged species. In certain aspects, the metal complex of TcPP, when a salt, may be a monocarboxylate salt, a dicarboxylate salt, a tricarboxylate salt, or a tetracarboxylate salt. Alternatively, one or two of the nitrogens of the porphyrin ring may be mono or di-protonated.

In certain aspects, the dye may be a is selected from the group consisting of carminic acid, erythrosine, litholrubin BK, tartrazine, chlorophyllin or a salt thereof, a metal complex of chlorophyllin, N3 ruthenium dye, methylene blue, Rose Bengal, Sunset Yellow FCF, Brilliant Blue FCF, Indigo Carmine, Quinoline Yellow, Patent Blue V, Allura Red AC, Carmoisine (Red 10), Ponceau 4R (Red 18), and Fast Green FCF (Green 3). Such dyes are known to a person of ordinary skill in the art.

In certain aspects, the dye may include black dyes (e.g., tris(isothiocyanato)-ruthenium (II)-2,2′:6′,2″-terpyridine-4,4′,4″-tricarboxylic acid, tris-tetrabutylammonium salt), orange dyes (e.g., tris(2,2′-bipyridyl-4,4′-dicarboxylato) ruthenium (II) dichloride, purple dyes (e.g., cis-bis(isothiocyanato)bis-(2,2′-bipyridyl-4,4′-dicarboxylato)-ruthenium (II)), red dyes (e.g., an eosin), green dyes (e.g., a merocyanine) and blue dyes (e.g., a cyanine).

In certain aspects, the dye may be a ruthenium dye such as Z907, K19, K51, K60, K68, K77, K78, N3, N719, all of which are known to a person of ordinary skill in the art. In certain aspects, the dye may be an anthocyanin dye, or a squaraine dye. In certain aspects, the dye may be MK-2 or MK-14:

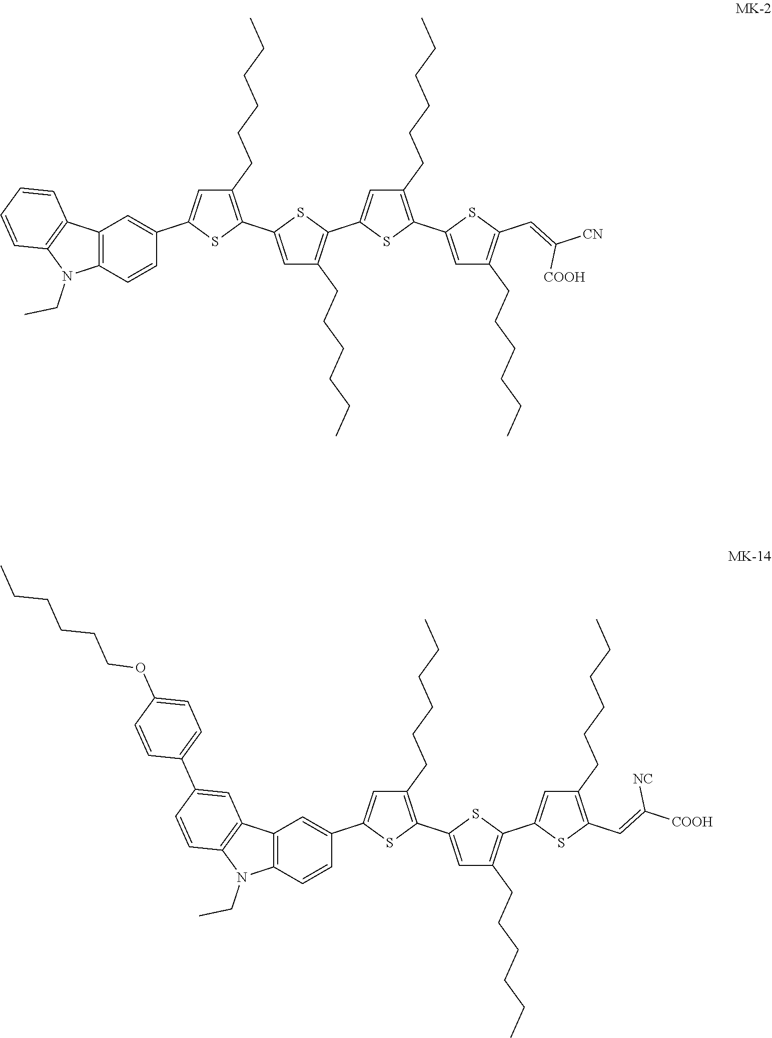

In certain aspects, the dye can be modified to have anchoring groups that will bond the dye to the surface of the TiO2. For example, a Chromophore C can be chemically modified to have a linker group bonded to it. For example, Rose Bengal can be linked to an acyl group as represented by the compound of formula (III):

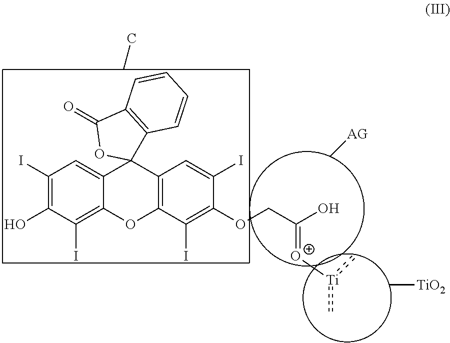

wherein C is the Rose Bengal chromophore, the acyl group is the anchoring group. In certain aspects, the linker of AG is the methyl group and the polar moiety is the carboxyl group.

With any reactive group on the dye, e.g., an alcohol, amine, thiol, carboxylate, sulfate, and the like, the person of ordinary skill in the art will understand that such reactive groups can be alkylated, acylated, or similarly modified through nucleophilic reactions or addition elimination reactions with appropriate reagents.

In a representative example, the compound of formula (III) can be synthesized by reacting Rose Bengal in an aqueous solution with molar two equivalents of hydroxide base. After chilling to about 0 deg C., 1 equivalent of methyl 2-chloroacetate is added and the reaction stirred for 24 hours. The pH is lowered to 2, and the reaction mixture washed with diethyl ether, dried over Magnesium Sulfate, and the solution concentrated in vacuo. The concentrate is then subjected to hydrolysis conditions in either aqueous acid or base solution, and isolated as understood by the person of ordinary skill in the art. The free acid is then mixed with TiO₂ to produce the complex of formula (III).

In certain embodiments, the dye has an acceptable molar extinction coefficient (e) in the wavelength range or value chosen. For example, a dye may have at least about 8,000 (e.g., at least about 10,000, at least about 13,000, at least 14,000, at least about 15,000, at least about 18,000, at least about 20,000, at least about 23,000, at least about 25,000, at least about 28,000, and at least about 30,000) at a given wavelength (e.g., A max) within the visible light spectrum.

In certain aspects, the weight/weight ratio of TiO₂ to the dye may be from about 100:1 to about 1:10, or from about 90:1 to about 1:10, or from about 80:1 to about 1:10, or from about 70:1 to about 1:10, or from about 60:1 to about 1:10, or from about 50:1 to about 1:10, or from about 40:1 to about 1:10, or from about 30:1 to about 1:10, or from about 20:1 to about 1:10, or from about 10:1 to about 1:10, or from about 1:1 to about 1:10, or from about 1:1 to about 1:20, or from about 1:1 to about 1:30, or from about 1:1 to about 1:40, or from about 1:1 to about 1:50, or from about 1:1 to about 1:60.

In certain aspects, the amount of the dye in the packaging composition is from about 100 g of dye per kg of packaging composition (100 g/kg), or about or about 110, about 120, about 130, about 140, about 150, about 160, about 170, about 180, about 190, about 200, about 210, about 220, about 230, about 240, about 250, about 260, about 270, about 280, about 290, or about 300 g/kg; or the amount of dye may be a range encompassing any of the foregoing values.

In certain aspects, the amount of the TiO₂ in the packaging composition is from about 100 g of dye per kg of packaging composition (100 g/kg), or about or about 110, about 120, about 130, about 140, about 150, about 160, about 170, about 180, about 190, about 200, about 210, about 220, about 230, about 240, about 250, about 260, about 270, about 280, about 290, or about 300 g/kg; or the amount of dye may be a range encompassing any of the foregoing values.

In certain aspects, the effective amount of the coordination complex is effective to reduce a population of a microorganism by from about 1 to about 6 log CFU units after the coordination complex is subject to the visible light for a first period of a time of from 4 hours per day to about 24 hours per day. The first period of time may be about 4, about 5, about 6, about 7, about 8, about 9, about 10, about 11, about 12, about 13, about 14, about 15, about 16, about 17, about 18, about 19, about 20, about 21, about 22, about 23, or about 24 hours per day; or the amount of dye may be a range encompassing any of the foregoing values.

The log CFU reduction may be about 1, about 2, about 3, about 4, about 5, about 6, about 7, about 8, about 9, about 10, about 11 or about 12 log CFU units; or may be a range encompassing any of the foregoing values.

In certain aspects, the effective amount, as defined below, of the coordination complex is at least 5% more effective than the otherwise same composition without the dye. The dye may be about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, or about 95% more effective; or the more effectiveness may be a range encompassing any of the foregoing values.

In certain aspects, the effective amount, as defined below, of the coordination complex is at least 5% more effective than the otherwise same composition without the TiO2. The TiO2 may be about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, or about 95% more effective; or the more effectiveness may be a range encompassing any of the foregoing values.

### The Thermoplastic Polymer

In certain aspects, the thermoplastic polymer may be any of those known to a person of ordinary skill. For example, a polyethylene, a polyethylene terephthalate, a polypropylene, a polystyrene, a polyester, a polyamide, and a polycarbonate may be utilized in the food packaging composition.

In certain aspects, the thermoplastic polymer may be a polyethylene, for example, an Ultra-high-molecular-weight polyethylene (UHMWPE), an Ultra-low-molecular-weight polyethylene (ULMWPE or PE-WAX), a High-molecular-weight polyethylene (HMWPE), a High-density polyethylene (HDPE), a High-density cross-linked polyethylene (HDXLPE), a Cross-linked polyethylene (PEX or XLPE), a Medium-density polyethylene (MDPE), a Linear low-density polyethylene (LLDPE), a Low-density polyethylene (LDPE), a Very-low-density polyethylene (VLDPE), or a Chlorinated polyethylene (CPE).

In certain aspects, the thermoplastic polymer may be a polypropylene. For example, the polypropylene may be a homopolymer, a random copolymer, or a block copolymer. The polypropylene may be atactic, syndiotactic, or isotactic. In certain aspects, the thermoplastic polymer may be a polyethylene terephthalate (PET), or a biaxially oriented PET (BoPET). In certain aspects, the thermoplastic polymer may be a transparent polystyrene, for example, an atactic, syndiotactic, or isotactic polystyrene, or a copolymerized polystyrene, for example a block copolymer of styrene and butadiene.

In certain aspects, the thermoplastic polymer may be a polyester. For example, the polyester may be a linear aliphatic high molecular weight polyester (Mₙ>10,000), an aliphatic linear low-molar-mass (Mₙ<10,000) hydroxy-terminated polyester, or a hyperbranched polyester. In certain aspects, the thermoplastic may be a polyimide, for example an aliphatic polyamide, a polyphthalamide, or an aramid.

In certain aspects, the thermoplastic polymer may be a polymer made from biodegradable monomers. For example, the thermoplastic polymer is selected from the group consisting of a cellulose, a cellulose derivative, a starch, a starch derivative, a lignin, a lignin derivative, a gelatin, a zein, an alginate, a pullulan, a polylactide, a polybutylene adipate terephthalate, a polycaprolactone, a polyhydroxyalkanoate, a polybutylene succinate, and a combination thereof.

### Methods of Making Food Packaging Compositions

Creating a food packaging composition that includes additives admixed therein involves a process of compounding or blending the polymer with the desired additives. This process ensures that the additives are thoroughly dispersed and incorporated into the polymer matrix, resulting in a sufficiently homogenous composition with desired properties.

The method can include selecting a suitable polymer based on the application and that will serve as the base material for the composition. Thermoplastic polymers can vary in their characteristics, such as flexibility, strength, thermal stability, and compatibility with additives. Common polymers used include polyethylene (PE), polypropylene (PP), polystyrene (PS), polyvinyl chloride (PVC), or other thermoplastics depending on the specific application and requirements.

The type and the amount of the additives will vary depended on the end use, including the specific form of the packaging or container and the specific food products. The compositions will include at least a coordination complex described herein in an amount effective to accomplish the desired effect of preserving the specific food product when used in the container.

Other additives can be selected based on the desired functionality. Additives can include fillers, reinforcing agents, plasticizers, stabilizers, flame retardants, colorants, or other specialized additives. These additives can enhance properties such as strength, flexibility, heat resistance, UV stability, flame resistance, or color.

The methods can involve preprocessing of the polymers and/or the additives. Many polymers have an inherent moisture content or can absorb moisture from the environment, which can negatively impact processing and the final properties of the blend. Therefore, drying the polymer can be used to remove moisture prior to compounding. Drying offers several benefits including improved processing, reduced degradation, and improved homogeneity. Moisture in the polymer can cause issues such as poor melt flow, bubbles, voids, or uneven dispersion of additives during blending. Drying the polymer ensures better processability, leading to more consistent and reliable compounding. Some polymers, when exposed to moisture at high temperatures, can undergo hydrolysis, resulting in degradation and undesirable properties. Drying minimizes the chances of such degradation reactions. Moisture can also create agglomerates or cause uneven distribution of additives in the polymer matrix. Drying facilitates better blending, dispersion, and homogeneity of the additives within the polymer.

The thermoplastic polymer can then be compounded or blended with the chosen additives, including the coordination complex. The compounding or blending process can involve mixing the polymer with the selected additives to achieve a uniform distribution throughout the polymer matrix. This can be done through various methods, including melt blending, solution blending, or solid-state blending.

When manipulating these methods, it can be important to monitor the blend's properties through various tests, including visual inspection, microscopy, rheology, and mechanical testing. Evaluating the blend's characteristics can provide insights into its homogeneity, dispersion, and processing behavior. If the desired properties are not achieved, adjustments to the parameters may be necessary. If the dispersion is poor, increasing the mixing time or intensity may help achieve better blending and dispersion. If the blend exhibits agglomeration or poor particle distribution, adjusting the particle size reduction process or adding flow aids during blending can enhance uniformity. If the blend exhibits degradation or reduced thermal stability, optimizing the temperature profile, screw speed, or residence time can help mitigate these issues.

### Melt Blending

Melt blending is a widely used method for compounding polymers with additives. In melt blending, the polymer and additives are combined in a melt state using equipment such as extruders or mixers. The high shear and temperature facilitate thorough mixing, melting, and homogenization of the components. The resulting molten mixture is then solidified into a desired form, such as pellets, sheets, or granules.

The polymer resin, additives, and other ingredients can be selected and pre-processed as needed. This can involve drying the polymer to remove moisture or incorporating additives into a suitable form, such as powders or pellets.

The polymer resin and additives can be accurately weighed and fed into an extruder, which is a machine designed for melting and mixing materials. Manipulating the feed rate of additives into the extruder affects the concentration and distribution of additives within the polymer matrix. Increasing the feed rate can lead to higher additive concentrations, while decreasing the feed rate can result in a lower additive content.

The extruder typically contains a barrel with a rotating screw that conveys and melts the materials as they progress through the barrel. Modifying the design and configuration of the mixing elements in the extruder screw can impact the shear forces and mixing efficiency. Different designs, such as mixing elements with varying pitches, can be employed to optimize the dispersion and blending of additives.

Increasing the screw speed in an extruder can enhance the shear forces and mixing efficiency, aiding in better dispersion of additives. However, excessively high speeds may lead to increased melt temperature and potential degradation of the polymer. High shear forces generated by the screw and barrel ensure thorough blending and distribution of the additives.

Inside the extruder, the polymer resin and additives are subjected to heat and mechanical shear. The heat causes the polymer to melt, while the rotating screw facilitates the mixing and dispersion of additives throughout the molten polymer. Adjusting the temperature profile along the extruder barrel can influence the melt viscosity, melt temperature, and residence time. Higher temperatures generally promote better melt flow and mixing, but excessive temperatures can cause degradation or reduced thermal stability.

The molten blend exits the extruder through a die, where it is shaped into the desired form, such as pellets or a continuous profile. The material is then cooled using air or water to solidify it into the final composition.

### Solution Blending

In solution blending, the polymer and additives are dissolved in a common solvent to form a homogeneous solution. The solution is then dried to remove the solvent, leaving behind a solid composition. This method is suitable for certain polymers and additives that are soluble in the chosen solvent. In food packaging, it can also be important to choose solvents that are safe for food contact especially in the case where complete solvent removal is impossible of impractical.

The polymer and additives can be individually or collectively dissolved in a suitable solvent to form a homogeneous solution. The choice of solvent depends on the polymer and additives' solubility and compatibility. The choice of solvent can influence the solubility of the polymer and additives and the resulting blend properties. Selecting a solvent with better compatibility and solubility for the components can improve the uniformity of the blend. If the solubility is inadequate, changing to a more suitable solvent or adjusting the solvent-to-additive ratio may be necessary.

The solution is thoroughly mixed using techniques such as stirring, agitation, or gentle heating to ensure complete blending and dispersion of the additives within the solvent. The duration and intensity of mixing impact the blending efficiency and homogeneity of the solution. Increasing the mixing time and speed can enhance the dispersion and interaction between the polymer and additives. However, excessive mixing can sometimes cause degradation or unwanted reactions, so careful optimization can be required.

The blended solution is subjected to a controlled evaporation or drying process to remove the solvent. This can be achieved through techniques such as rotary evaporation, vacuum drying, or spray drying, resulting in the formation of a solid composition. The rate of solvent removal during drying or evaporation affects the final composition. Adjusting the drying conditions, such as temperature, airflow, or vacuum, can control the solvent removal rate. A slower evaporation rate may promote better diffusion and blending of additives, while a faster rate can lead to quicker solidification.

### Solid-State Blending

Solid-state blending involves mixing the polymer in a solid state, typically as powder or pellets, with the desired additives. This can be achieved using equipment such as tumbling mixers, high-intensity mixers, or milling equipment. The process aims to achieve a uniform distribution of additives throughout the polymer particles.

If the polymer or additives have larger particle sizes, they can undergo a size reduction process, such as grinding or milling, to achieve a more uniform particle size distribution and improve blend homogeneity.

The polymer and additives can be combined in a mixing apparatus, such as a tumbler, high-intensity mixer, or milling equipment. The mechanical action applied during mixing promotes the dispersion and intermingling of the components, resulting in a homogeneous mixture. The mixing duration, mixing speed, and other parameters can be optimized to ensure the additives are uniformly distributed throughout the polymer matrix. Careful monitoring and control of the blending process are important to achieve consistent and reproducible results.

### Food Packaging Containers

A variety of food packaging containers are known to those skilled in the art and will be readily recognized as capable of using the food packaging compositions described herein. The food packaging containers can include containers such as clam shell containers and deli containers, bags and pouches, wraps and films, cups and lids, trays, and packaging inserts. Depending upon the specific choice of container, various methods and forms of the food packaging composition can be employed to make the container.

The containers can be made by injection molding, in particular where the food additive composition is in the form or pellets or granules or where the container has an intricate shape. Injection molding is often used for containers such as caps, closures, lids, and other containers with intricate shapes. In injection molding, the thermoplastic composition in pellet or granule form is melted in an injection molding machine. The molten material is then injected into a mold cavity under high pressure. After cooling and solidification, the mold is opened, and the food container is ejected. Injection molding allows for the production of complex container shapes with precise dimensions. When creating injection molded containers, it can be important to optimize the melt temperature, injection speed, mold temperature, cooling time, packing pressure, holding time, or cycle time. These parameters can help to ensure proper melt flow, dimensional accuracy, avoidance of defects, and efficient production rates.

The containers can be made by thermoforming, in particular where the food additive composition is in the form of resins or resin sheets or where the container is a tray, cup, or clamshell. Thermoforming involves heating a resin sheet to its softening temperature and placing it over a mold. The sheet is then vacuum-formed or pressure-formed onto the mold to create the desired container shape. After cooling, the container is trimmed and finished. Thermoforming is commonly used for producing disposable food containers like trays, cups, and clamshells. When creating thermoformed containers, it can be important to optimize parameters such as heating temperature, sheet thickness, forming pressure, forming time, cooling time, plug assist pressure, mold release. These parameters can determine the material softening, stretching, and cooling rates, ensuring proper forming, shape accuracy, and efficient production.

The containers can be made by extrusion, in particular where the food packaging composition is in the form of a pellet, granules, or powder orwhere the containers include sheets or films. Extrusion is a continuous process where the thermoplastic composition is fed into an extruder, where it is heated, melted, and forced through a die. The extrudate is then shaped into the desired container form, such as sheets, films, or profiles. The extruded material is subsequently cooled and processed further, if required, before being cut into the final container shape. When creating extruded containers, it can be important to optimize parameters such as extruder temperature profile, screw speed, melt pressure, die design, cooling rate, haul-off speed, cutting speed. These parameters control the melt viscosity, melt temperature, die swell, cooling rate, and dimensional accuracy of the extruded product.

The containers can be made by blow molding, in particular where the food packaging composition is in the form of a resin or resin sheet or where the container is a bottle, jar, or other container with a hollow shape. Blow molding is used for producing hollow food containers like bottles or jars. The process begins with heating and melting the resin or resin sheet. The molten material is then extruded to form a parison—a tube-like shape. The parison is placed inside a mold, and compressed air is introduced to expand and shape the material against the mold walls. After cooling, the container is released from the mold. When creating blow-molded containers, it can be important to optimize parameters such as Parison extrusion rate, mold temperature, blow air pressure, cooling time, clamp force, stretch ratio. These parameters influence parison formation, stretching, blowing, cooling, and ensure proper wall thickness, neck finish, and container dimensions.

The containers can be made by lamination, in particular where the food packaging composition is in the form of a film or foil or the container included a multi-layered pouch or laminated structure. Lamination involves bonding multiple layers of films or foils together to create a multi-layered structure. This is typically achieved through processes like adhesive bonding or heat sealing. The layers may consist of the food packaging composition with additives along with other materials like barrier films or print films. Lamination improves the overall properties of the container, such as barrier properties, strength, and printability. When creating laminated containers, it can be important to optimize parameters such as lamination temperature, pressure, speed, dwell time, adhesive properties, substrate selection. These parameters control the bonding strength, adhesive flow, material compatibility, and ensure proper barrier properties, printability, and overall structure integrity.

The containers can be made by thermo-sealing, in particular where the food packaging composition is in the form of a film or foil or where the container includes pouches, sachets, or single-serve packages. Thermo-sealing is used to create food containers such as pouches or sachets. It involves sealing pre-formed films or foils together using heat and pressure. The food packaging composition with additives can be utilized as one of the layers in the structure. Thermo-sealing ensures product integrity and provides airtight or tamper-evident packaging solutions. When creating containers via thermos-sealing, it can be important to optimize parameters such sealing temperature, sealing pressure, dwell time, cooling time, film properties, pressure distribution. These parameters ensure proper sealing strength, integrity, airtightness, and prevent leakage or contamination.

These methods are common in the food packaging industry and allow for the production of a wide range of food containers with various shapes, sizes, and functionalities. The choice of the specific manufacturing method depends on factors such as the desired container design, material form, production volume, and cost considerations. The design of the specific container, including the placement of the food packaging composition, can be made considering the overall container design and the specific food product to be packaged. In some aspects, a portion of the food packaging container such as a wall or other surface, will be designed to be transparent or translucent to light of from about 100 nm to about 1500 nm, preferably from about 300 nm to about 800 nm. In some aspects, the food packaging composition is in the form of an insert such as a pouch or strip that is designed to contact the food product when in use and to be exposed to light through the packaging, e.g. through a transparent or translucent portion of the container when the container is exposed to ambient light. In some aspects, the food packaging composition is laminated or bonded to the container, e.g. is laminated or bonded to the transparent portion of the container.

### Methods of Using Food Packaging Compositions and Containers

Methods of using the food packaging compositions and containers are also provided. The methods can include making containers or food packaging using the compositions. The methods can also include preventing food spoilage in a food product in need thereof, increasing the shelf life of a food product in need thereof, or other methods of food preservation. These methods can include contacting the food product with a food packaging composition described herein or placing the food product in a container described herein, followed by exposing the food product (including exposing the container or the food packaging composition) to suitable light having intensity in the visible region e.g., in the range of about 100 nm to about 1500 nm or about 300 nm to about 800 nm.

### DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the disclosure and relevant art and should not be interpreted in an idealized or overly formal sense unless expressly defined herein.

The articles “a” and “an,” as used herein, mean one or more when applied to any feature in aspects of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “food products”, as used herein, is to be understood in a broad sense and includes meat products, fish products, dairy products, beverage products, baking products, unpasteurized food products, salads, and sauces, marinades, salsas, and seasonings. In some embodiments, the food product contains one or more meat products such as beef, pork, poultry, or fish.

The food products can be ready-to-eat food products. The term “ready-to-eat” means the food product is distributed to be consumed without further preparation by the consumer or distributed to not require cooking or preparation to achieve food safety prior to consumption.

The term “meat product”, as used herein, includes any food product that primarily contains animal tissue, e.g. contains at least 70%, at least 80%, at least 90%, or at least 95% animal tissue including, but not limited to, beef, pork, poultry, and fish. Other animal tissues can include the tissue of many ungulates that can be used for human consumption such as deer, oxen, antelope, sheep, and goat. The term “meat product” as used herein encompasses processed meats (such as sausages, hamburgers, luncheon meats and cold cuts) and pre-prepared meat dishes such as meat pies, fish pies, game pies, stews, lasagnas and other meat-containing pasta dishes, chicken Kiev, chicken cordon-bleu, chicken-a-la-king, meat rolls, meatloaf, pates, sushi, sashimi, salmon mousses, fishcakes, stir-fries etc. The term “ready-to-eat meat product” should include any meat product, which is distributed to be consumed without further preparation by the consumer or distributed to not require cooking prior to consumption. Ready-to-eat meat products include, but are not limited to, pates, hot dogs, bologna, ham, salami, sausages, deli meats, cold cuts, and dried or cured meat products. Ready-to-eat meat products can include ready-to-eat beef products, ready-to-eat pork products, ready-to-eat poultry products, and ready-to-eat fish products.

The term “beef product”, as used herein, refers to any food that primarily contains cow tissue, e.g. contains at least 70%, at least 80%, at least 90%, or at least 95% cow tissue. The term “cow” refers to any animal of the genus Bos, such as for example the Bos Taurus, which is used as a food source for human consumption. Exemplary cow breeds used as commercial livestock include the Holstein, Ayrshire, Angus, and Limousin.

The term “poultry product”, as used herein, refers to any food that primarily contains poultry tissue, e.g. contains at least 70%, at least 80%, at least 90%, or at least 95% poultry tissue. The term “poultry” refers to any edible birds such as chickens, turkeys, ducks, geese, and squab. Poultry can include animals of the genus Gallus, for example the Gallus domesticus, which is used as a food source for human consumption. Poultry can include animals of the genus Meleagris, for example the Meleagris gallopavo, which is used as a food source for human consumption.

The term “pork product”, as used herein, refers to any food product that primarily contains pig tissue, e.g. contains at least 70%, at least 80%, at least 90%, or at least 95% pig tissue. The term “pig” refers to any animal of the genus Sus, such as for example Sus Scrofa, which is used as a food source for human consumption. Exemplary pig breeds used as commercial livestock include Berkshire, Large White, Duroc, Hampshire, Landrace, Meishan, Pietrain, and many others.

As used herein, the term “fish product” should include any food product that primarily contains tissue from an aquatic animal, e.g. contains at least 70%, at least 80%, at least 90%, or at least 95% tissue from an aquatic animal. Aquatic animals can include lobster, crab, freshwater fish, smoked salmon, smoked other fish, salted fish, saltwater fish and other seafood.

As used herein, the term “dairy product” should include any food product made using milk or milk products, including, but not limited to, milk, yogurt, ice cream, cheese, skimmed milk, acidified milk, butter milk, condensed milk, spreads, margarines, milk powder, butter, EMC (Enzyme Modified Cheese), dulce de leche, coffee whitener; coffee creamer, cream, sour cream, ghee, and dairy analogue. Cheese may be any cheese, e.g. fresh cheese, hard cheese, curd cheese, cream cheese, white mold cheese, blue mold cheese and process cheese.

As used herein, an “agricultural product” may be selected from the group consisting of roots, tubers, rhizomes, bulbs, coitus, stems, branches, leaf stems, bracts, leaf sheaths, leaves, needles, blooms, buds, flowers, petals, fruits, seeds, and edible fungi.

As used herein, an “agricultural product” may be selected from the group consisting of achoccha, amaranth, angelica, anise, apple, arrowroot, arugula, artichoke, globe, artichoke, Jerusalem, asparagus, atemoya, avocado, balsam apple, balsam pear, Bambara groundnut, bamboo, banana, plantains, Barbados cherry, beans, beet, blackberry, blueberry, Bok choy, boniato, broccoli, Chinese broccoli, Raab broccoli, Brussels sprouts, bunch grape, burdock, cabbage, cabbage, sea-kale, swamp cabbage, calabaza, cantaloupes, muskmelons, capers, carambola (star fruit), cardoon, carrot, cassava, cauliflower, celeriac, celery, celtuce, chard, Chaya, chayote, chicory, Chinese jujube, chives, chrysanthemum, chufa, cilantro, citron, coconut palm, collards, comfrey, corn salad, corn, Cuban sweet potato, cucumber, cuscus, daikon, dandelion, dasheen, dill, eggplant, endive, eugenia, fennel, fig, galia muskmelon, garbanzo, garlic, gherkin, ginger, ginseng, gourds, grape, guar, guava, Hanover salad, horseradish, huckleberry, ice plant, jaboticaba, jackfruit, jicama, jojoba, kale, kangkong, kelp, kohlrabi, leek, lentils, lettuce, longan, loquat, lovage, luffa gourd, lychee, macadamia, malanga, mamey sapote, mango, martynia, melon, casaba, melon, honeydew, Momordica, muscadine grape, mushroom, muskmelons, mustard, mustard collard, naranjillo, nasturtium, nectarine, okra, onion, orach, oranges, papaya, paprika, parsley, parsley root, parsnip, passion fruit, peach, plum, peas, peanuts, pear, pecan, pepper, persimmon, pimiento, pineapple, pitaya, pokeweed, pomegranate, potato, sweet potato, pumpkin, purslane, radicchio, radish, rakkyo, rampion, raspberry, rhubarb, romaine lettuce, roselle, rutabaga, saffron, salsify, sapodilla, sarsaparilla, sassafras, scorzonera, sea kale, Seagrape, seaweed, sargassum, shallot, skirret, smallage, sorrel, soybeans, spinach, spondias, squash, strawberries, sugar apple, swamp cabbage, sweet basil, sweet corn, sweet potato, Swiss chard, tomatillo, tomato, tree tomato, truffles, turnip, upland cress, water celery, water chestnut, watercress, watermelon, yams, and zucchini.

As used herein, the term “unpasteurized food product” should include any food product, whereby at least one ingredient is unpasteurized and which undergoes no final heat treatment.

As used herein, an “effective amount” is at least the minimum concentration required to have a measurable decrease in the growth rate of one of more microorganisms or a measurable decrease in the amount of one or more microorganisms. An effective amount can substantially prevent the growth of one or more microorganisms for a period of time up to about 5 days, 7 days, 10 days, 14 days, 21 days, 25 days, 30 days, or 45 days. A secondary inhibitor is said to substantially prevent the growth of one or more microorganisms when the secondary inhibitor reduces the rate of growth of one or more microorganisms by at least 10%, at least 20%, at least 30%, at least 40%, at least 50%, at least 60%, at least 70%, at least 80%, at least 90%, at least 95%, or at least 99% at 39±1 °F as compared to the same sample under the same conditions except without the secondary inhibitor.

Substantially preventing the growth of one or more microorganisms can include reducing the amount of the microorganism present after 3, 7, 9, 11, 14, 30, 60, 90, or 120 days or longer at 39±1 °F as compared to the level of the microorganism present after the same time in otherwise the same sample except without the secondary inhibitor. Substantially preventing the growth of one or more microorganisms can include completely eliminating the growth of the microorganism, reducing the amount of the microorganism, or completely eliminating the microorganism after a period of about 3, 7, 9, 11, 14, 30, 60, 90, or 120 days or longer at 39±1 °F. According to Food and Drug Administration United States Public Health Service 2013 Food Code, the refrigerated shelf-life at retail counter should not exceed 30 days and food items should be discarded after that. Additionally, deli-sliced RTE products should be held at 41 °F or below for no more than 7 days once the package is opened for slicing.

The term “daily value”, as used herein, can be given the meaning supplied by the United States Food and Drug Administration (U.S. F.D.A.), for example as described in the “Guidance for Industry: A Food Labeling Guide” published by the Office of Nutrition, Labeling, and Dietary Supplements of the U.S. F.D.A., last revised January 2013. There are two sets of reference values for reporting nutrients in nutrition labeling: 1) Daily Reference Values (DRVs) and 2) Reference Daily Intakes (RDIs). These values assist consumers in interpreting information about the amount of a nutrient present in a food and in comparing nutritional values of food products. DRVs are provided for total fat, saturated fat, cholesterol, total carbohydrate, dietary fiber, sodium, potassium, and protein. RDIs are provided for vitamins and minerals and for protein for children less than four years of age and for pregnant and lactating women. To limit consumer confusion, the single term “daily value”, often denoted as “DV”, is used to designate both the DRVs and RDIs. For substances where no RDI or DRV has been established, the DV can be taken, for example, as the average daily intake of the substance based on food intake concentrations for persons over 2 years old on a standard 2,000-calorie diet.

The term “generally recognized as safe” or “GRAS”, as used herein, refers to substances generally recognized, among qualified experts, as having been adequately shown to be safe under the conditions of its intended use, for example by general recognition of safety through scientific procedures under 21 C.F.R § 170.30(b) or by general recognition of safety through experience based on common use in foods by a substantial history of consumption for food use under 21 C.F.R § 170.30(c). GRAS substances can include those substances listed in 21 C.F.R. § 182.

The term “safe”, as used herein with reference to food, refers to a state wherein the food is sufficiently free of pathogenic micro-organisms or the toxic products of microbial growth to be fit for human or animal consumption.

As used herein, the term “shelf life” refers to the period of time that a food product remains saleable to retail customers and remains fit and safe for use or consumption. Changes including, but not limited to, oxidation, odor development, discoloration in addition to microbial changes can alter the shelf life of the food product. In traditional meat processing, the shelf life of fresh meat and meat by-products is about 30 to 40 days after an animal has been slaughtered. Refrigeration of meat during this period of time largely arrests and/or retards the growth of micro-organisms. After about 30 to 40 days, however, refrigeration can no longer effectively control the proliferation of micro-organisms. Micro-organisms present on meat products after this time period may have proliferated to a great extent and/or have generated unacceptable levels of undesirable by-products. Spoilage micro-organisms may also act to discolor meat, making such meat unappealing and undesirable for human consumption. Pathogenic micro-organisms may have proliferated in this time period to a level wherein they can cause disease in an animal that consumes the food product.

As used herein, the term “usable life” refers to the period of time that a high-pressure processed food product remains fit for human consumption, e.g., safe and substantially free of food spoilage, after having been removed from the original packaging. For example, deli-style ready-to-eat meat products may be opened and sliced at the deli counter. The unsliced meat at the deli counter will have a usable life different from the sliced deli meat. The usable life will depend upon factors such as the storage temperature, the surface area, and the handling conditions.

“Food spoilage”, as used herein, refers to organoleptic changes in the food, i.e. alterations in the condition of food which makes it less palatable, for example, changes in taste, smell, texture or appearance which are related to contamination of the food with one or more spoilage micro-organisms. Spoiled food may or may not be safe for consumption.

“Food preservation”, as used herein, refers to methods which maintain or enhance food safety for example, by controlling the growth and proliferation of pathogenic and spoilage micro-organisms, thus guarding against food poisoning, and delaying or preventing food spoilage. Food preservation helps food remain safe for consumption for longer periods of time (i.e. improves the shelf life) and inhibits or prevents nutrient deterioration and/or organoleptic changes which cause food to become less palatable.

The term “micro-organism” as used herein, includes bacteria, fungi and parasites. Non-limiting examples of micro-organisms that can be controlled using the formulations and methods described herein include bacteria from the genus Aeromonas (e.g., A. hydrophilia), Arcobacter, Bacillus (e.g. B. cereus), Brochothrix (e.g. B. thermosphacta), Campylobacter (e.g. C. jejuni), Carnobacterium (e.g. C. piscicola), Chlostridium (e.g. C. perfringens, C botulinum), Enterobacteriacae, Escherichia (e.g. E. coli O157:H7), Listeria (e.g., L. monocytogenes), Pseudomonas (e.g., P. putida, P. fluorescens), Salmonella (e.g., S. Typhimurium), Serratia (e.g., S. liquefaciens), Shigella, Staphylococcus (e.g., S. aureus), Vibrio (e.g. V. parahaemolyticus, V. cholerae) and Yersinia (e.g., Y. enterocolitica); fungi such as Aspergillus flavum and Penicillium chrysogenum; parasites such as Amoebiasis (Emoebiasis histolytica), Balantidiosis (Balantidiosis coli), Entamoeba histolytica, Cryptosporidiosis (e.g. Cryptosporidium parvum), Cyclosporidiosis (e.g., Cyclospora cayetanensis), Giardiasis (e.g., Giardia lamblia, Giardia intestinalis), Isosporiasis (Isosporiasis belli), Microsporidiosis (Enterocytozoon bieneusi, S. intestinalis), Trichinella spiralis and Toxoplasma gondii. The term micro-organism also refers to vegetative or dormant forms of bacteria and fungi, such as spores wherein activation of the growth cycle may be controlled using the methods provided herein.

The term “spoilage micro-organism” as used herein refers to a micro-organism that acts to spoil food. Spoilage micro-organisms may grow and proliferate to such a degree that a food product is made unsuitable or undesirable for human or animal consumption. The production of undesirable by-products by the microorganism, such as carbon dioxide, methane, nitrogenous compounds, butyric acid, propionic acid, lactic acid, formic acid, sulfur compounds, and other gases and acids can cause detrimental effects on the food product alteration of the color of meat surfaces to a brown, grey or green color, or creation of an undesirable odor. The color and odor alterations of food products due to the growth of spoilage micro-organisms frequently result in the product becoming unsaleable.

The term “pathogenic micro-organism” as used herein refers to a micro-organism capable of causing disease or illness in an animal or a human, for example, by the production of endotoxins, or by the presence of a threshold level of micro-organisms to cause food poisoning, or other undesirable physiological reactions in humans or animals.

### ASPECTS OF THE DISCLOSURE

The present disclosure will be better understood upon reading the following numbered aspects, which should not be confused with the claims. In some instance, the aspects below may be combined with one or more additional aspects or with other aspects described elsewhere in the disclosure and accompanying examples. All such variations and combinations are intended to be covered by the instant disclosure.
Aspect 1. A food packaging composition comprising a thermoplastic polymer and an effective amount of a coordination complex comprising TiO₂ and a dye which absorbs in the electromagnetic spectrum from about 100 nm to about 1500 nm.
Aspect 2. A food packaging composition of Aspect 1, wherein the dye is a compound of formula (I)

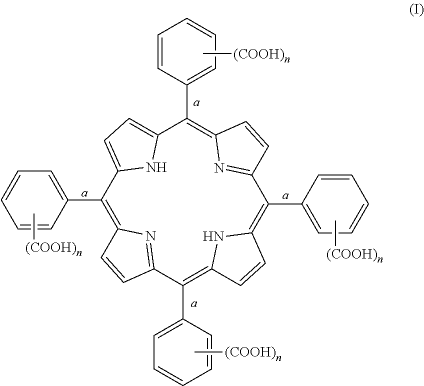

or a salt thereof, wherein n is 1 or 2, and a is a bond.
Aspect 3. The food packaging composition of Aspect 1 or Aspect 2, wherein n is 1 and each COOH group is para to bond a.
Aspect 4. The food packaging composition of any one of Aspects 1-3, wherein n is 2 and each COOH group is meta to bond a.
Aspect 5. The food packaging composition of any one of Aspects 1-4, wherein the dye is a metal complex of TcPP (tetrakis(4-carboxyphenyl)porphyrin]) selected from the group consisting of Cu—TcPP, Zn—TcPP, Fe-TcPP, and Ni-TcPP.
Aspect 6. The food packaging composition of any one of Aspects 1-5, wherein the dye is a compound selected from the group consisting of carminic acid, erythrosine, litholrubin BK, tartrazine, and a metal complex of chlorophyllin, N3 ruthenium dye, methylene blue, Rose Bengal, Sunset Yellow FCF, Brilliant Blue FCF, Indigo Carmine, Quinoline Yellow, Patent Blue V, Allura Red AC, Carmoisine (Red 10), Ponceau 4R (Red 18), and Fast Green FCF (Green 3)
Aspect 7. The food packaging composition of any one of Aspects 1-6, wherein the coordination complex comprises the TiO₂ having one or more of the dye adsorbed on a surface of the TiO₂.
Aspect 8. The food packaging composition of any one of Aspects 1-7, wherein a plurality of dye is adsorbed on the surface of each TiO₂.
Aspect 9. The food packaging composition of any one of Aspects 1-8, wherein the coordination complex comprises the dye covalently associated with a surface of the TiO₂ through a dative bond.
Aspect 10. The food packaging composition of any one of Aspects 1-9, wherein a plurality of the dye is associated with the surface of each TiO₂ through dative bonds.
Aspect 11. The food packaging composition of any one of claims 1-10, wherein the dye comprises an anchoring group selected from the group consisting of carboxylic acids, thiols, and silanes; and wherein the reactive anchoring group forms a dative bond with the surface of the TiO₂.
Aspect 12. The food packaging composition of any one of Aspects 1-11, wherein the w/w ratio of TiO₂ to the compound of formula (I) is from 50:1 to 1:5.
Aspect 13. The food packaging composition of any one of Aspects 1-12, wherein the w/w ratio of TiO₂ to the compound of formula (I) is from 10:1 to 1:10.
Aspect 14. The food packaging composition of any one of Aspects 1-13, wherein the amount of the compound of formula (I) is from about 0.1 g per kg of the total weight of the food packaging composition (g/kg) to about 300 g/kg.
Aspect 15. The food packaging composition of any one of Aspects 1-14, wherein the amount of TiO₂ is from about 100 g per kg of the total weight of the food packaging composition (g/kg) to about 300 g/kg.
Aspect 16. The food packaging composition of any one of Aspects 1-15, wherein the effective amount of the coordination complex is effective to reduce a population of a microorganism by from about 1 to about 6 log CFU units after the coordination complex is subject to the visible light for a first period of a time of from 4 hours per day to about 24 hours per day for a period of at least 14 days.
Aspect 17. The food packaging composition of any one of Aspects 1-16, wherein the microorganism is a spoilage microorganism.
Aspect 18. The food packaging composition of any one of Aspects 1-17, wherein the microorganism is a pathogenic microorganism.
Aspect 19. The food packaging composition of any one of Aspects 1-18, wherein the effective amount of the coordination complex is at least 25% more effective than the otherwise same composition except without the dye when exposed to the same conditions.
Aspect 20. The food packaging composition of any one of Aspects 1-19, wherein the effective amount of the coordination complex is at least 25% more effective than the otherwise same composition except without the TiO₂ when exposed to the same conditions.
Aspect 21. The food packaging composition of any one of Aspects 1-20, wherein the thermoplastic polymer is selected from the group consisting of a polyethylene, a high-density polyethylene, a low-density polyethylene, a polyethylene terephthalate, a polypropylene, a polystyrene, a polyester, a polyamide, and a polycarbonate, a copolymer thereof, and a blend thereof.
Aspect 22. The food packaging composition of any one of Aspects 1-21, wherein the polymer is selected from the group consisting of a cellulose, a cellulose derivative, a starch, a starch derivative, a lignin, a lignin derivative, a gelatin, a zein, an alginate, a pullulan, a polylactide, a polybutylene adipate terephthalate, a polycaprolactone, a polyhydroxyalkanoate, a polybutylene succinate, a copolymer thereof, and a blend thereof.
Aspect 23. The food packaging composition of any one of Aspects 1-22, effective to extend a shelf life of a food product by from about 10% to about 500% when compared to a shelf life of the otherwise same packaged food product except without the coordination complex when exposed to the same conditions.
Aspect 24. The food packaging composition of any one of claims 1 to 23, wherein the packaging is effective to extend a useable life of a food product by from about 10% to about 500% of the useable life of the otherwise same food product except without the coordination complex when exposed to the same conditions.
Aspect 25. The food packaging composition of any one of claims 1 to 24, wherein the packaging is effective to prevent food spoilage for a time of from 10% to 500% of a spoilage time of the otherwise same food product except without the coordination complex when exposed to the same conditions.
Aspect 26. The food packaging composition according to any one of claims 1-25, wherein the dye is generally recognized as safe.
Aspect 27. A food packaging comprising the food packaging composition of any one of Aspects 1-26.
Aspect 28. The food packaging container of any one of Aspects 1-27, comprising a wall comprising the food packaging composition, wherein a portion of the wall is transparent or translucent to light of from about 100 nm to about 1500 nm.
Aspect 29. The food packaging container of any one of Aspects 1-28, wherein the portion of the wall is transparent or translucent to light of 380 nm to 800 nm.
Aspect 30. The food packaging container of any one of Aspects 1-29, wherein the container comprises a base, a food product reversibly mounted on the base, and a transparent or translucent film of the food packaging composition, which film encloses the base and the food product.
Aspect 31. The food packaging container of any one of Aspects 1-30, which comprises a transparent or translucent film of the food packaging composition enclosing a food product.
Aspect 32. The food packaging container of any one of Aspects 1-31, comprising a food product is in contact with the food packaging composition.
Aspect 33. The food packaging container of any one of Aspects 1-32, wherein the food packaging container is selected from the group consisting of containers such as clam shell containers and deli containers, bags and pouches, wraps and films, cups and lids, trays, and packaging inserts.
Aspect 34. The food packaging container of any one of Aspects 1-33, wherein the food packaging composition is coating at least a portion of a surface of the container.
Aspect 35. The food packaging container of any one of Aspects 1-34, wherein the surface that is coated is an internal food-contacting surface.
Aspect 36. The food packaging container of any one of Aspects 1-35, wherein the food packaging composition is in a film that is laminated or bonded the container.
Aspect 37. The food packaging container of any one of Aspects 1-36, wherein the food packaging composition is in an insert.
Aspect 38. A method of preventing food spoilage in a food product in need thereof, the method comprising:
   a. contacting the food product with a composition of any one of Aspects 1-26 or a packaging container of any one of Aspects 27-37; and
   b. exposing the composition or packaging container to light having a wavelength of from about 100 nm to about 1500 nm.
Aspect 39. A method of increasing the shelf life of a food product in need thereof, the method comprising:
   a. contacting the food product with a composition of any one of Aspects 1-26 or a packaging container of any one of Aspects 27-37; and
   b. exposing the composition or packaging container to light having a wavelength of from about 100 nm to about 1500 nm.
Aspect 40. A method of food preservation of a food product in need thereof, the method comprising
   a. contacting the food product with a composition of any one of Aspects 1-26 or a packaging container of any one of Aspects 27-37;
   b. exposing the composition or packaging container to light having a wavelength of from about 100 nm to about 1500 nm.
Aspect 41. The method of any one of Aspects 38-40, wherein the food product is a ready-to-eat food product.
Aspect 42. The method of any one of Aspects 38-40, wherein the method comprises exposing the composition or packaging container to the light for a period of time from about 4 hours to about 12 hours per day.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure. Efforts have been made to ensure accuracy with respect to numbers (e.g., amounts, temperature, etc.), but some errors and deviations should be accounted for. Unless indicated otherwise, parts are parts by weight, temperature is in ° C or is at ambient temperature, and pressure is at or near atmospheric.

Titanium dioxide (TiO2) nanoparticles (Anatase, <25 nm) and TcPP were purchased from Sigma Aldrich (St Louis, MO, USA). Lighted experiments were carried out using a GVM RGB LED Video Lighting Kit, 800D Studio Video Lights with APP Control, nominal power: 40 W.

All experiments were conducted a minimum of three times. To compare two treatments, a student's t-test was utilized, while for comparisons among multiple treatments, a one-way Analysis of Variance (ANOVA) complemented by Tukey's HSD test was used. The analyses were carried out using JMP Pro 16 software. A p-value of less than 0.05 was deemed statistically significant.

### Example 1

Preparation of Dye Solutions and TiO₂+Dye Suspensions: Generally, the dyes tested in the present description were water soluble. TiO₂ and dye suspensions were prepared according to the following general procedure: 1 g of TiO₂ nanoparticles were slowly added to stirred 100 mL of ethanolic solution of a dye (e.g., TcPP) at a concentration of 1 mM. The resulting suspension was continuously stirred at 60 °C for 16 hr in the dark to form TiO₂-dye conjugate. The mixture was centrifuged at 10,000 rpm for 10 min and the supernatant removed to excess dye. The precipitate after centrifugation was washed with ethanol further remove any remaining dye. The solid conjugates were then resuspended in 100 mL ethanol to provide a 10 mg/mL suspension.

### Example 2

Preparation of Cellulose Nanofiber (CNF) films: CNF was homogenized in HPLC-grade water at 1,000 psi to make a 3% CNF slurry. TiO₂—TcPP conjugate (0-100 mg) was suspended in HPLC-grade water and mixed with the CNF slurry, poured into Petri dishes (dia. 100 mm) at 20 mL per Petri dish and dried in atmosphere-controlled chamber at room temperature and 50% relative humidity for 48-72 h. The final content of conjugate in CNF film ranges from 0 to 2.0 mg/cm².

### Example 3

Analysis of Generated Reactive Oxygen Species (ROS): To identify and quantify different types of ROS generated by TiO₂—TcPP conjugates under visible light irradiation, hydroxyl radical, singlet oxygen, superoxide anion, and hydrogen peroxide were measured using methods described by Shuai et al with minor modifications. One percent (1%) ethanolic suspensions of TiO2 or TiO₂-TcPP conjugates were mixed with para-chlorobenzoic acid (p-CBA, 98%, Sigma-Aldrich), furfuryl alcohol (FFA) or 2,3-bis(2-methoxy-4-nitro-5-sulfophenyl)-2H-tetrazolium-5-carboxanilide (XTT, Cayman Chemical), respectively. The mixtures were exposed under LED light (6,000 lux) for 1 to 3 days, and the decays of p-CBA and FFA were monitored by high performance liquid chromatography (HPLC) which indicated generation of hydroxyl radical and singlet oxygen. XTT decay was analyzed by monitoring the change of absorbance at 470 nm using a UV-Visible light spectrometer. H₂O₂ generation was analyzed by monitoring color changes of N,N-diethyl-1,4-phenylenediammonium sulfate (DPD) using the spectrophotometric method.

### Example 4

Microorganism Culture Preparation: An Escherichia coli culture was prepared by reviving E. coli from a stock strain, which involved streaking it onto a Tryptic Soy Agar (TSA) plate, followed by a 24-hr incubation at 37 °C. A single colony was selected, inoculated in a Tryptic Soy Broth (TSB) tube, and incubated at the same temperature for an additional 24 hr to reach a bacterial count of 10⁸ CFU/mLF. Serial dilution in TSB using a 0.1% PBS solution, yielded a population of approximately 105 CFU/mL. A similar procedure was employed to prepare populations of Leuconostoc lactis and Pseudomonas fluorescens.

### Example 5

Efficacy Measurement: Nine hundred (900) μL of the 105 CFU/mL E. coli suspension was added to each well of a 24-well plate, followed by the addition of 100 μL of TiO2-TcPP conjugate suspension. One hundred (100) μL of sterile water, ethanol, TcPP solution, and TiO2 suspension were added to each well. The 24-well plate was then placed in an incubator illuminated by a dimmable LED panel (GVM brand) and incubated at 4 °C for 24 hours. The light intensity was carefully regulated between 700 and 7,000 lux, as confirmed using a light meter. A similar procedure was employed to test efficacy against populations of Leuconostoc lactis and Pseudomonas fluorescens.

A duplicate 24-well plate was prepared and incubated under the same conditions. Following the 24-hour incubation period, the E. coli population in each well was spiral plated onto TSA plates. The population differences between the illuminated plate and the dark controls were compared.

The bactericidal properties of conjugate-containing CNF films were examined on both liquid (PBS solution) and agar media. For liquid-based assays, CNF films with varying conjugate loadings were cut into circular discs (⅝ inch in diameter). The discs were placed at the bottom of wells of a 24-well plate, each of which was then supplemented with 1 mL of the 105 CFU/mL E. coli suspension. The 24-well plates were incubated under visible light or in darkness for 24 hr, after which the cultures were evaluated as described above.

For agar-based tests, a diluted E. coli suspension (105 CFU/mL) was swabbed and spread across a TSA plate. Circular discs of CNF films, each containing different concentrations of conjugates, were placed on the inoculated TSA plate. The plate was subsequently incubated at room temperature under a visible light exposure of 6,000 lux for 24 h. The diameters of the inhibitory zones around film discs were recorded.

### Example 6

Cucumbers were used as a model food matrix to assess the bacteriostatic potential of conjugate-embedded CNF films. Fresh cucumbers were meticulously washed and sanitized using 70% ethanol and the ethanol was allowed to evaporate. The cucumber's peel and top layer were aseptically sliced into square coupons measuring 20 mm×20 mm, which were then placed in a Petri dish. Ten microliters of the 105 CFU/mL E. coli culture were dispensed onto each cucumber coupon. Films laden with 0.3-2 mg/cm² of conjugates were cut to size to entirely cover the cucumber coupons. The Petri dish, now containing the cucumber coupons and film covers, was then recapped and situated in an incubator equipped with an LED panel (6000 lux) and left to incubate at 4 °C for 24 hours. After incubation, both the cucumber coupon and film cover were aseptically transferred to a tube containing 0.1% peptone solution. Subsequently, the E. coli population was enumerated using spiral plating on MacConkey Agar plates.

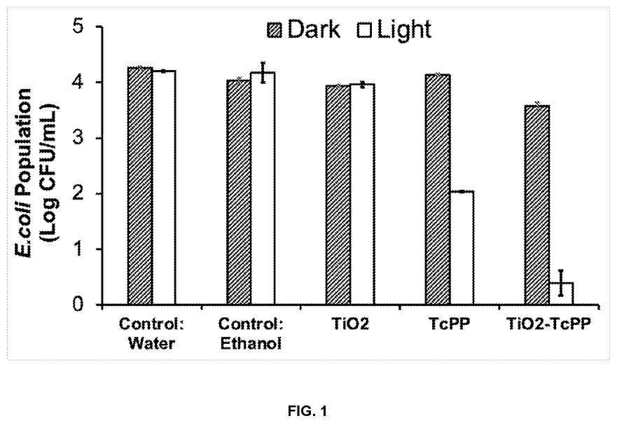

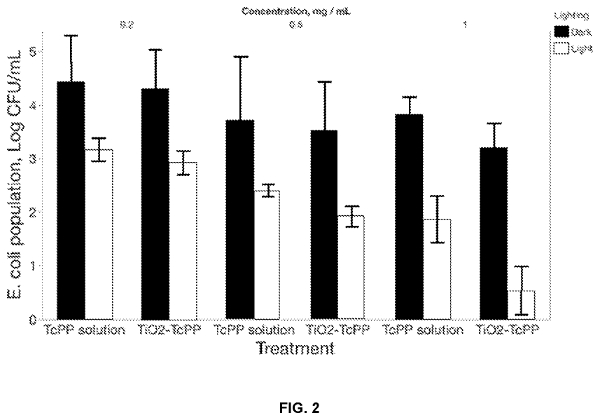

The inhibitory effect of TiO₂—TcPP conjugate was analyzed by adding conjugate suspensions in vitro E. coli culture and verifying the change of E. coli population compared with controls. Multiple levels of suspended conjugate were added to E. coli culture, and TiO₂ suspension (zero TcPP), TcPP solution (zero TiO₂), and sterile water only were all tested as controls. Results are summarized in FIG. 1 and FIG. 2. The TiO₂-only treatment did not provide significant reduction of E. coli after incubation under light, indicating visible light did not sensitize TiO₂. When TCPP alone was incubated under visible light, it inhibited the growth of E. coli. Furthermore, although the TCPP solution with no TiO₂ showed an inhibitory effect to E. coli, the inhibition was greater when the same concentration of TcPP was present with TiO₂ as a TiO₂—TcPP conjugate. This indicates a synergetic effect between TcPP and TiO2. While not being bound to a theory, it is proposed that the TCPP, a photocatalytic dye, absorbs energy from visible light and transfer electrons to TiO₂ which may then generate reactive oxygen species (ROS)[87].

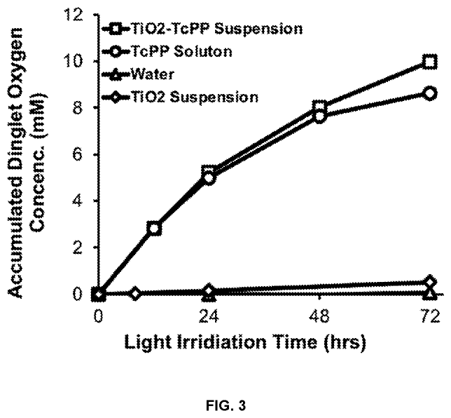

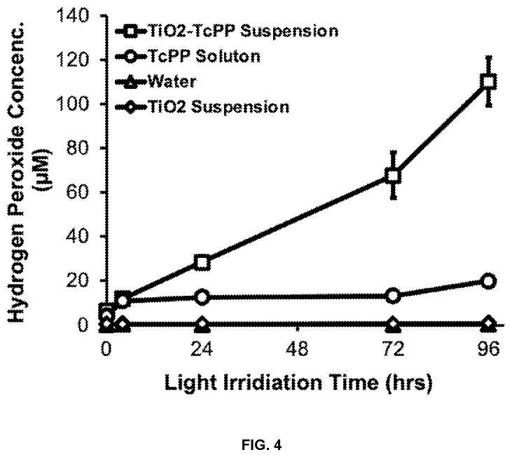

Several assays were employed to analyze the generation of theoretically possible ROSs during the light-sensitization of TiO₂-TCPP. The results of a furfuryl alcohol (FA) assay of singlet oxygen and DPD assay of hydrogen peroxide are demonstrated in FIG. 3 and FIG. 4. In FIG. 3, FFA gradually decomposed within 72 h of incubation with either TCPP solution or TiO₂-TCPP conjugate, while FFA, in control experiments, and with TiO₂-only treatments, had almost no changes. FIG. 4 reveals further differences in ROS-generating capacities between TCPP and a TiO₂-TCPP conjugate.

The conjugate, when exposed under visible light, generated more H₂O₂ over time; in contrast, the TCPP solution under light generated a smaller amount of H₂O₂. These results, when combined, confirmed the observation that the conjugate exhibited stronger inhibitory activity against E. coli than the TCPP solution only.

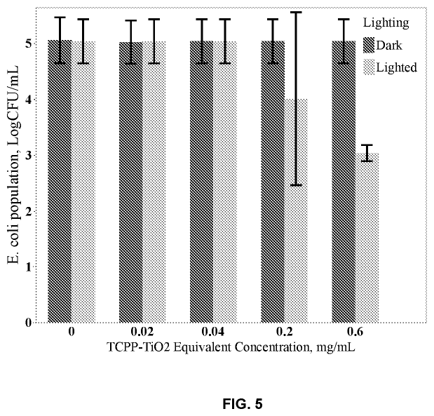

The conjugate was incorporated into the CNF films at different concentrations. The films were cut into a universal round size (see above) and submerged into an E. coli solution to test for a light-sensitized bacteriostatic effect. Results showed that TiO₂-TCPP conjugate at 0.1 mg/cm², or 0.2 mg/mL decelerated growth of E. coli; at 0.6 mg/mL, the inhibition was statistically significant (FIG. 5).

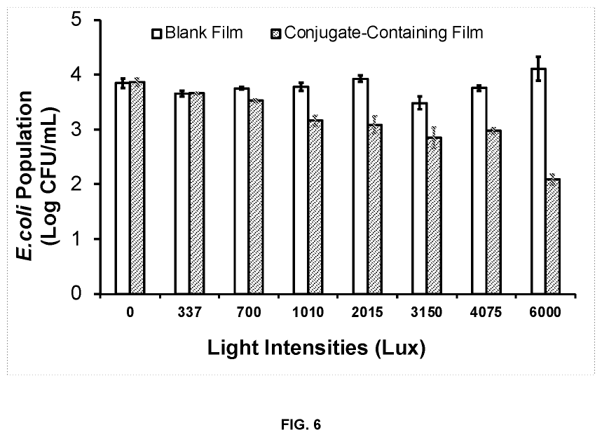

Light intensity was a factor that influenced bacteriostatic activity of the CNF film. Based on tested light intensities, light started to sensitize TCPP at around about 700 lux and inhibition to E. coli increased along with the increasing light intensity from 700 to 7000 lux. (FIG. 6)

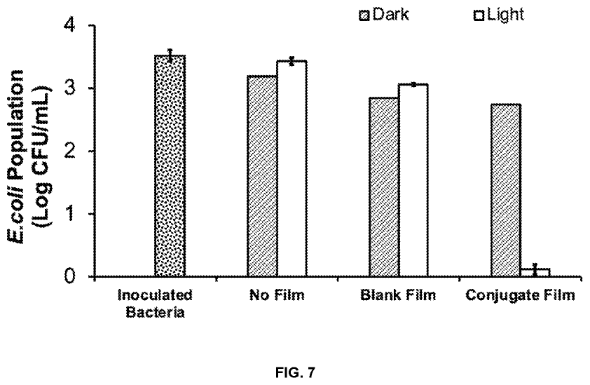

The bacteriostatic activity of a TiO₂-TCPP incorporated CNF film was tested on cucumber as a direct application to improve food safety. Results are summarized in FIG. 7. CNF film containing 0.3 mg/cm² TiO₂-TCPP conjugate was able to decrease the population of E. coli by about 3 log CFU/mL. Increased concentration of conjugate slightly increased the inhibition.

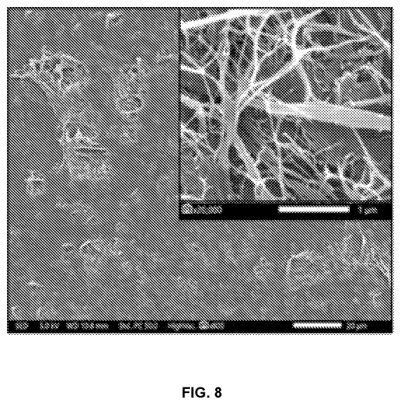

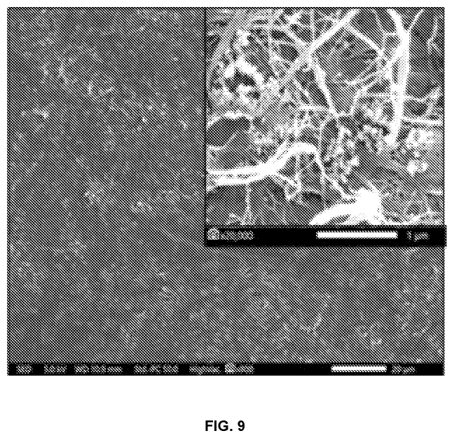

The surface morphology of CNF films with incorporated TiO₂—TcPP conjugate were observed by scanning electron microscopy as shown in FIG. 8 and FIG. 9. In FIG. 9, TiO₂—TcPP conjugate was seen dispersed within the gaps and pores among cellulose nanofibers. As concentration of conjugate increases, gaps were filled with more conjugate particles. Under lower magnification (×800), the surface morphology showed no difference with or without conjugate added.

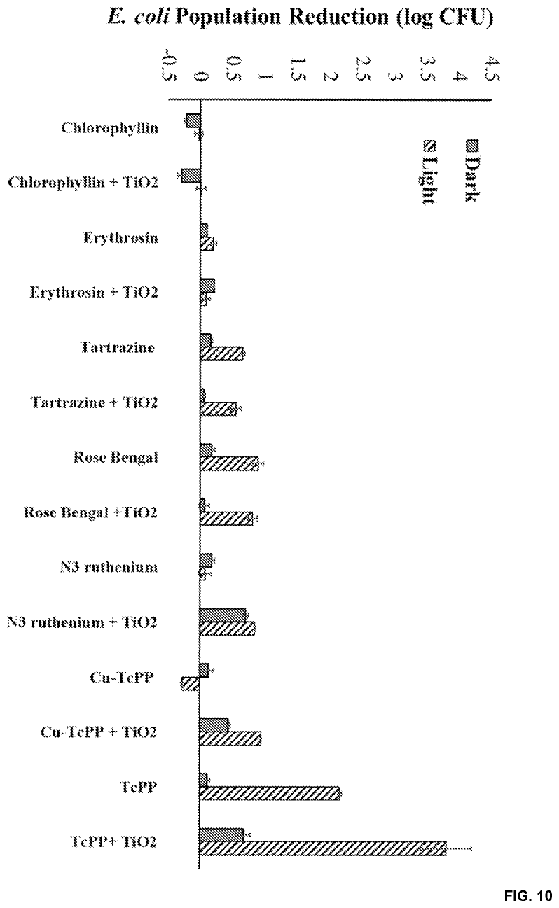

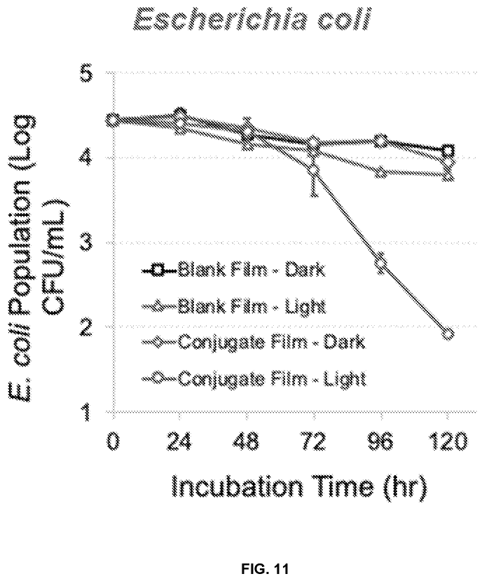

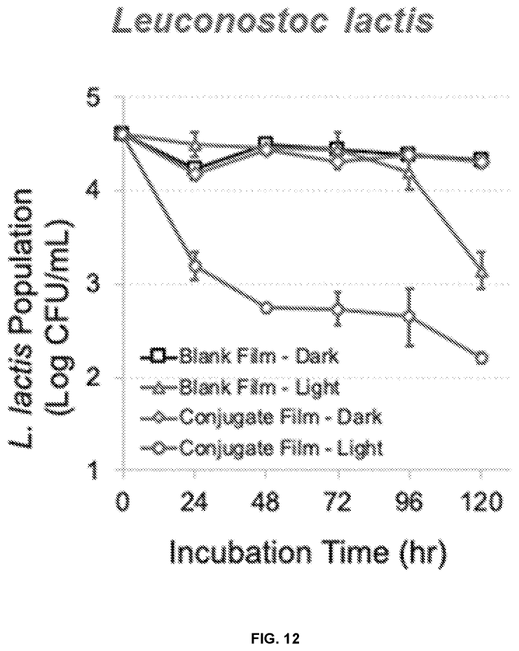

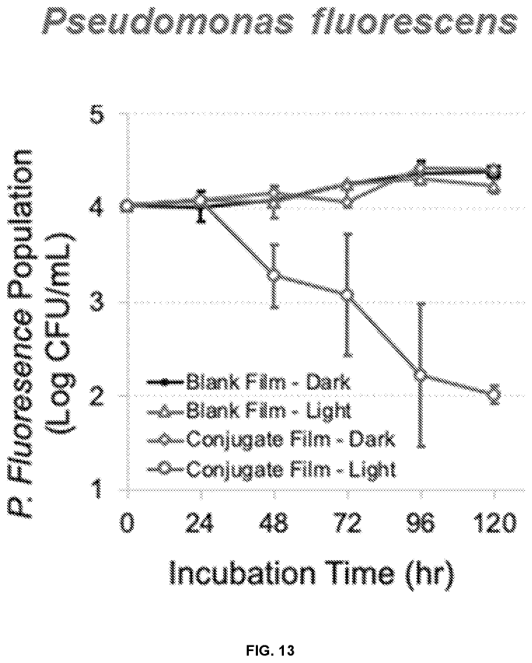

The effect of various dyes suspended in water with TiO₂ is shown in FIG. 10. The antimicrobial effect of the packaging composition is shown in detail in FIG. 11, FIG. 12, and FIG. 13, wherein three different species were controlled after 96 hours of light transmission at 3000 lux.

The tensile strength and elasticity of the of the TiO₂—TcPP incorporated CNF film were determined using the ASTM (1997) “Standard Test Method For Tensile Properties Of Thin Plastic Sheeting, Standard” Designation D 882-97. A TA.XTPLUS texture analyzer was utilized to carry out the Standard Test method. The results of the measurements are shown in Table 1:

TABLE 1
Tensile strength and % Elasticity
of TiO2—TcPP incorporated CNF film

| Film | TS (MPa) | % E |
|---|---|---|
| Blank Film | 50.2 ± 1.1 | 25.2 ± 3.8 |
| Conjugate-containing film | 42.5 ± 2.7 | 16.2 ± 0.7 |
| (15) | | |
| Conjugate-containing film | 42.5 ± 1.3 | 12.5 ± 1.1 |
| (100) | | |

### REFERENCES

Unless specified elsewhere in the disclosure, references cited in the disclosure are enumerated below. References may be cited herein using the format of reference number(s) enclosed by parentheses corresponding to one or more of the following numbered references. References may also be cited herein using a superscript format. For example, citation of references numbers 1 and 2 immediately herein below could be indicated in the disclosure as (Refs. 1 and 2) or as the superscript “1-2.”

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. Furthermore, any incorporation by reference of patents and patent applications to which the instant application claims priority is not intended to extend to any lexicographical definitions in the patents and patent applications so incorporated and should not be read as limiting the accompanying claims.

The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.
(1) Cannella, D.; Möllers, K. B.; Frigaard, N.-U.; Jensen, P. E.; Bjerrum, M. J.; Johansen, K. S.; Felby, C. J. N. c., Light-driven oxidation of polysaccharides by photosynthetic pigments and a metalloenzyme. 2016, 7, 11134.
(2) Chawengkijwanich, C.; Hayata, Y., Development of TiO2 powder-coated food packaging film and its ability to inactivate Escherichia coli in vitro and in actual tests. Int. J. Food Microbiol. 2008, 123 (3), 288-292.
(3) Chorianopoulos, N.; Tsoukleris, D.; Panagou, E.; Falaras, P.; Nychas, G.-J., Use of titanium dioxide (TiO2) photocatalysts as alternative means for Listeria monocytogenes biofilm disinfection in food processing. Food Microbiol. 2011, 28 (1), 164-170.
(4) Long, M.; Wang, J.; Zhuang, H.; Zhang, Y.; Wu, H.; Zhang, J., Performance and mechanism of standard nano-TiO2 (P-25) in photocatalytic disinfection of foodborne microorganisms-Salmonella typhimurium and Listeria monocytogenes. Food Control 2014, 39, 68-74.
(5) Kim, B.; Kim, D.; Cho, D.; Cho, S., Bactericidal effect of TiO2 photocatalyst on selected food-borne pathogenic bacteria. Chemosphere 2003, 52 (1), 277-281.
(6) Pelaez, M.; Nolan, N. T.; Pillai, S. C.; Seery, M. K.; Falaras, P.; Kontos, A. G.; Dunlop, P. S.; Hamilton, J. W.; Byrne, J. A.; O'shea, K., A review on the visible light active titanium dioxide photocatalysts for environmental applications. Applied Catalysis B: Environmental 2012, 125, 331-349.
(7) Ouattara, B.; Simard, R.; Piette, G.; Begin, A.; Holley, R., Diffusion of acetic and propionic acids from chitosan-based antimicrobial packaging films. Journal of food science 2000, 65 (5), 768-773.
(8) Hauser, C.; Thielmann, J.; Muranyi, P., Organic acids: Usage and potential in antimicrobial packaging. In Antimicrobial Food Packaging, Elsevier: 2016; pp 563-580.
(9) Ünalan, I. U.; Korel, F.; Yemenicioǧlu, A., Active packaging of ground beef patties by edible zein films incorporated with partially purified lysozyme and Na2EDTA. International journal of food science & technology 2011, 46 (6), 1289-1295.
(10) Iseppi, R.; Pilati, F.; Marini, M.; Toselli, M.; de Niederhäusern, S.; Guerrieri, E.; Messi, P.; Sabia, C.; Manicardi, G.; Anacarso, I., Anti-listerial activity of a polymeric film coated with hybrid coatings doped with Enterocin 416K1 for use as bioactive food packaging. International Journal of Food Microbiology 2008, 123 (3), 281-287.
(11) Ramesh, T.; Nayak, B.; Amirbahman, A.; Tripp, C. P.; Mukhopadhyay, S. J. I. f. s.; technologies, e., Application of ultraviolet light assisted titanium dioxide photocatalysis for food safety: A review. 2016, 38, 105-115.
(12) Lee, M.; Shahbaz, H. M.; Kim, J. U.; Lee, H.; Lee, D.-U.; Park, J. J. F. m., Efficacy of UV-TiO2 photocatalysis technology for inactivation of Escherichia coli K12 on the surface of blueberries and a model agar matrix and the influence of surface characteristics. 2018, 76, 526-532.
(13) Tang, S.; Wang, Z.; Li, P.; Li, W.; Li, C.; Wang, Y.; Chu, P. J. N., Degradable and photocatalytic antibacterial Au—TiO2/sodium alginate nanocomposite films for active food packaging. 2018, 8 (11), 930.
(14) Maisch, T. J. P.; Sciences, P., Resistance in antimicrobial photodynamic inactivation of bacteria. 2015, 14 (8), 1518-1526.
(15) Pryor, W. A., Oxy-radicals and related species: Their formation, lifetimes, and reactions. Annu. Rev. Physiol. 1986, 48 (1), 657-667.
(16) Lisdat, F., Electrochemical Sensors for the Detection of Superoxide and Nitric Oxide-Two Biologically Important Radicals. In Ultrathin Electrochemical Chemo-and Biosensors: Technology and Performance, Mirsky, V. M., Ed. Springer-Verlag Berlin Heidelberg, 2004; Vol. 2, pp 141-155.
(17) FAO, Global Food Losses and Food Waste-Extent, Causes and Prevention. Food and Agriculture Organization, Rome. 2011.
(18) Gunders, D.; Bloom, J., Wasted: How America is losing up to 40 percent of its food from farm to fork to landfill. Natural Resources Defense Council New York: 2017.
(19) FAFAO, The state of food insecurity in the world 2015. Meeting the 2015 international hunger targets: taking stock of uneven progress [Internet]. Food and Agriculture Organization of the United Nations, International Fund . . . : 2015.
(20) Poyatos-Racionero, E.; Ros-Lis, J. V.; Vivancos, J.-L.; Martinez-Máñez, R., Recent advances on intelligent packaging as tools to reduce food waste. Journal of Cleaner Production 2018, 172, 3398-3409.
(21) Williams, H.; Wikström, F.; Otterbring, T.; Löfgren, M.; Gustafsson, A., Reasons for household food waste with special attention to packaging. Journal of cleaner production 2012, 24, 141-148.
(22) USCDC Estimates of Foodborne Illness in the United States. http://www.cdc.gov/foodborneburden/. Accessed Jul. 22, 2018.
(23) USCDC Attribution of Foodborne Illnesses, Hospitalizations, and Deaths to Food Commodities by using Outbreak Data, United States, 1998-2008. http://www.cdc.gov/foodborneburden/attribution-1998-2008.html. Accessed Jul. 22, 2018.
(24) USCDC CDC 2011 Estimates: Findings. http://www.cdc.gov/foodborneburden/2011-foodborne-estimates.html. Accessed Jul. 22, 2018.
(25) Malhotra, B.; Keshwani, A.; Kharkwal, H., Antimicrobial food packaging: potential and pitfalls. Frontiers in microbiology 2015, 6, 611.
(26) Sung, S.-Y.; Sin, L. T.; Tee, T.-T.; Bee, S.-T.; Rahmat, A.; Rahman, W.; Tan, A.-C.; Vikhraman, M., Antimicrobial agents for food packaging applications. Trends in Food Science & Technology 2013, 33 (2), 110-123.
(27) Fagan, R.; McCormack, D. E.; Dionysiou, D. D.; Pillai, S. C., A review of solar and
visible light active TiO2 photocatalysis for treating bacteria, cyanotoxins and contaminants of emerging concern. Materials Science in Semiconductor Processing 2016, 42, 2-14.
(28) Kumar, P.; Sandeep, K.; Alavi, S.; Truong, V.; Gorga, R., Preparation and characterization of bio-nanocomposite films based on soy protein isolate and montmorillonite using melt extrusion. Journal of Food Engineering 2010, 100 (3), 480-489.
(29) Matsunaga, T.; Tomoda, R.; Nakajima, T.; Nakamura, N.; Komine, T., Continuous-sterilization system that uses photosemiconductor powders. Appl. Environ. Microbiol. 1988, 54 (6), 1330-1333.
(30) Li, Y.; Zhang, W.; Niu, J.; Chen, Y., Mechanism of photogenerated reactive oxygen species and correlation with the antibacterial properties of engineered metal-oxide nanoparticles. ACS nano 2012, 6 (6), 5164-5173.
(31) Luo, P. G.; Stutzenberger, F. J., Nanotechnology in the detection and control of microorganisms. Advances in applied microbiology 2008, 63, 145-181.
(32) Yemmireddy, V. K.; Hung, Y. C., Using photocatalyst metal oxides as antimicrobial surface coatings to ensure food safety-Opportunities and challenges. Comprehensive Reviews in Food Science and Food Safety 2017, 16 (4), 617-631.
(33) Sharma, K.; Sharma, V.; Sharma, S., Dye-sensitized solar cells: fundamentals and current status. Nanoscale research letters 2018, 13 (1), 381.
(34) Hagfeldt, A.; Boschloo, G.; Sun, L.; Kloo, L.; Pettersson, H., Dye-sensitized solar cells. Chemical reviews 2010, 110 (11), 6595-6663.
(35) Lee, B.; He, J.; Chang, R. P.; Kanatzidis, M. G., All-solid-state dye-sensitized solar cells with high efficiency. Nature 2012, 485 (7399), 486-489.
(36) Chen, D.; Huang, F.; Cheng, Y. B.; Caruso, R. A., Mesoporous anatase TiO2 beads with high surface areas and controllable pore sizes: a superior candidate for high-performance dye-sensitized solar cells. Advanced Materials 2009, 21 (21), 2206-2210.
(37) Zhang, J.; Chen, X.; Takanabe, K.; Maeda, K.; Domen, K.; Epping, J. D.; Fu, X.; Antonietti, M.; Wang, X., Synthesis of a carbon nitride structure for visible-light catalysis by copolymerization. Angewandte Chemie International Edition 2010, 49 (2), 441-444.
(38) Zhang, J.; Zhang, M.; Sun, R. Q.; Wang, X., A facile band alignment of polymeric carbon nitride semiconductors to construct isotype heterojunctions. Angewandte Chemie International Edition 2012, 51 (40), 10145-10149.
(39) Zheng, Q.; Durkin, D. P.; Elenewski, J. E.; Sun, Y.; Banek, N. A.; Hua, L.; Chen, H.; Wagner, M. J.; Zhang, W.; Shuai, D., Visible-light-responsive graphitic carbon nitride: rational design and photocatalytic applications for water treatment. Environmental science & technology 2016, 50 (23), 12938-12948.
(40) Nalbandian, M. J.; Greenstein, K. E.; Shuai, D.; Zhang, M.; Choa, Y.-H.; Parkin, G. F.; Myung, N. V.; Cwiertny, D. M., Tailored synthesis of photoactive TiO2 nanofibers and Au/TiO2 nanofiber composites: structure and reactivity optimization for water treatment applications. Environmental science & technology 2015, 49 (3), 1654-1663.
(41) Ye, T.; Durkin, D. P.; Banek, N. A.; Wagner, M. J.; Shuai, D., Graphitic carbon nitride supported ultrafine Pd and Pd—Cu catalysts: enhanced reactivity, selectivity, and longevity for nitrite and nitrate hydrogenation. ACS applied materials & interfaces 2017, 9 (33), 27421-27426.
(42) Durkin, D. P.; Ye, T.; Larson, E. G.; Haverhals, L. M.; Livi, K. J.; De Long, H. C.; Trulove, P. C.; Fairbrother, D. H.; Shuai, D., Lignocellulose fiber- and welded fiber-supports for palladium-based catalytic hydrogenation: a natural fiber welding application for water treatment. ACS Sustainable Chemistry & Engineering 2016, 4 (10), 5511-5522.
(43) Shen, H.; López-Guerra, E. A.; Zhu, R.; Diba, T.; Zheng, Q.; Solares, S. D.; Zara, J. M.; Shuai, D.; Shen, Y., Visible-Light-Responsive Photocatalyst of Graphitic Carbon Nitride for Pathogenic Biofilm Control. ACS applied materials & interfaces 2018, 11 (1), 373-384.
(44) Xia, D.; Shen, Z.; Huang, G.; Wang, W.; Yu, J. C.; Wong, P. K., Red phosphorus: an earth-abundant elemental photocatalyst for “green” bacterial inactivation under visible light. Environmental science & technology 2015, 49 (10), 6264-6273.
(45) Bader, H.; Sturzenegger, V.; Hoigne, J., Photometric method for the determination of low concentrations of hydrogen peroxide by the peroxidase catalyzed oxidation of N, N-diethyl-p-phenylenediamine (DPD). Water Research 1988, 22 (9), 1109-1115.
(46) Yang, S.-T.; Wang, X.; Jia, G.; Gu, Y.; Wang, T.; Nie, H.; Ge, C.; Wang, H.; Liu, Y., Long-term accumulation and low toxicity of single-walled carbon nanotubes in intravenously exposed mice. Toxicology letters 2008, 181 (3), 182-189.
(47) Sánchez-Polo, M.; Salhi, E.; Rivera-Utrilla, J.; Von Gunten, U., Combination of ozone with activated carbon as an alternative to conventional advanced oxidation processes. Ozone: Science and Engineering 2006, 28 (4), 237-245.
(48) Chen, C.-Y.; Jafvert, C. T., Photoreactivity of carboxylated single-walled carbon nanotubes in sunlight: reactive oxygen species production in water. Environmental science & technology 2010, 44 (17), 6674-6679.
(49) Dionysiou, D. D.; Suidan, M. T.; Bekou, E.; Baudin, I.; Laîné, J.-M., Effect of ionic strength and hydrogen peroxide on the photocatalytic degradation of 4-chlorobenzoic acid in water. Applied Catalysis B: Environmental 2000, 26 (3), 153-171.
(50) Kähkönen, M. P.; Heinäsmäki, J.; Ollilainen, V.; Heinonen, M., Berry anthocyanins: Isolation, identification and antioxidant activities. J. Sci. Food Agric. 2003, 83 (14), 1403-1411.
(51) Ku, C.; Mun, S., Optimization of the extraction of anthocyanin from Bokbunja (Rubus coreanus Miq.) marc produced during traditional wine processing and characterization of the extracts. Bioresour. Technol. 2008, 99 (17), 8325-8330.
(52) Hosikian, A.; Lim, S.; Halim, R.; Danquah, M. K., Chlorophyll extraction from microalgae: A review on the process engineering aspects. Int. J. Chem. Eng. 2010, 2010, 391632.
(53) Barba, A. O.; Hurtado, M. C.; Mata, M. S.; Ruiz, V. F.; De Tejada, M. L. S., Application of a UV-vis detection-HPLC method for a rapid determination of lycopene and β-carotene in vegetables. Food Chem. 2006, 95 (2), 328-336.
(54) Choksi, P. M.; Joshi, V. Y., A review on lycopene-extraction, purification, stability and applications. Int. J. Food Prop. 2007, 10 (2), 289-298.
(55) Yan, Z.; Li, C.; Zhang, L.; Liu, Q.; Ou, S.; Zeng, X., Enzymatic acylation of anthocyanin isolated from black rice with methyl aromatic acid ester as donor: Stability of the acylated derivatives. J. Agric. Food Chem. 2016, 64 (5), 1137-1143.
(56) Giusti, M. M.; Wrolstad, R. E., Acylated anthocyanins from edible sources and their applications in food systems. Biochem. Eng. J. 2003, 14 (3), 217-225.
(57) Zhao, C.-L.; Yu, Y.-Q.; Chen, Z.-J.; Wen, G.-S.; Wei, F.-G.; Zheng, Q.; Wang, C.-D.; Xiao, X.-L., Stability-increasing effects of anthocyanin glycosyl acylation. Food Chem. 2017, 214, 119-128.
(58) Auwärter, W.; Écija, D.; Klappenberger, F.; Barth, J. V., Porphyrins at interfaces. Nature Chem. 2015, 7 (2), 105.
(59) Campbell, W. M.; Burrell, A. K.; Officer, D. L.; Jolley, K. W., Porphyrins as light harvesters in the dye-sensitised TiO₂ solar cell. Coord. Chem. Rev. 2004, 248 (13-14), 1363-1379.
(60) Granados-Oliveros, G.; Paez-Mozo, E. A.; Ortega, F. M.; Ferronato, C.; Chovelon, J.-M., Degradation of atrazine using metalloporphyrins supported on TiO₂ under visible light irradiation. Appl. Catal., B 2009, 89 (3-4), 448-454.
(61) Afzal, S.; Daoud, W. A.; Langford, S. J., Photostable self-cleaning cotton by a copper (II) porphyrin/TiO₂ visible-light photocatalytic system. ACS Appl. Mater. Interfaces 2013, 5 (11), 4753-4759.
(62) Polyakov, N. E.; Leshina, T. V.; Meteleva, E. S.; Dushkin, A. V.; Konovalova, T. A.; Kispert, L. D., Enhancement of the photocatalytic activity of TiO₂ nanoparticles by water-soluble complexes of carotenoids. J. Phys. Chem. B 2009, 114 (45), 14200-14204.
(63) Madrazo, M.; Kim, Y. T., Preparation of Packaging Aerogels Using NFC Reinforced with Industrial Hem, SWST/JWRS International Convention: Era of a Sustainable World. Tradition and Innovation for Wood Science and Technology in Japan 2018.
(64) Kim, Y. J.; Kim, Y. T., TEMPO-oxidized Nanofibrillated cellulose film (NFC) incorporating graphene oxide (GO) nanofillers. International Journal of biological Macromolecules (Under Review) 2020.
(65) Isogai, A.; Saito, T.; Fukuzumi, H., TEMPO-oxidized cellulose nanofibers. nanoscale 2011, 3 (1), 71-85.
(66) Blackman, I. C.; Frank, J. F., Growth of Listeria monocytogenes as a biofilm on various food-processing surfaces. Journal of food protection 1996, 59 (8), 827-831.
(67) Ryu, J.-H.; Beuchat, L. R., Biofilm formation by Escherichia coli 0157: H7 on stainless steel: effect of exopolysaccharide and curli production on its resistance to chlorine. Appl. Environ. Microbiol. 2005, 71 (1), 247-254.
(68) Molin, G., Measurement of the maximum specific growth rate in chemostat of Pseudomonas spp. with different abilities for biofilm formation. European journal of applied microbiology and biotechnology 1983, 18 (5), 303-307.
(69) Ramirez, M. D. F.; Smid, E. J.; Abee, T.; Groot, M. N. N., Characterisation of biofilms formed by Lactobacillus plantarum WCFS1 and food spoilage isolates. International journal of food microbiology 2015, 207, 23-29.
(70) Pedersen, K., Method for studying microbial biofilms in flowing-water systems. Appl. Environ. Microbiol. 1982, 43 (1), 6-13.
(71) Ranieri, M. R.; Whitchurch, C. B.; Burrows, L. L., Mechanisms of biofilm stimulation by subinhibitory concentrations of antimicrobials. Current opinion in microbiology 2018, 45, 164-169.
(72) Sánchez, M. C.; Llama-Palacios, A.; Marin, M. J.; Figuero, E.; León, R.; Blanc, V.; Herrera, D.; Sanz, M., Validation of ATP bioluminescence as a tool to assess antimicrobial effects of mouthrinses in an in vitro subgingival-biofilm model. Medicina oral, patologia oral y cirugia bucal 2013, 18 (1), e86.
(73) Xue, Z.; Sendamangalam, V. R.; Gruden, C. L.; Seo, Y., Multiple roles of extracellular polymeric substances on resistance of biofilm and detached clusters. Environmental science & technology 2012, 46 (24), 13212-13219.
(74) USCDC Reports of selected Salmonella outbreak investigations. http://www.cdc.gov/salmonella/outbreaks.html, Accessed Jul. 29, 2018.
(75) USCDC Reports of selected E. coli outbreak investigations. http://www.cdc.gov/ecoli/outbreaks.html, Accessed Jul. 29, 2018.
(76) GRAU, F. H.; VANDERLINDE, P. B., Growth of Listeria monocytogenes on vacuum-packaged beef. Journal of food protection 1990, 53 (9), 739-741.
(77) Leisner, J.; Greer, G.; Dilts, B.; Stiles, M., Effect of growth of selected lactic acid bacteria on storage life of beef stored under vacuum and in air. International journal of food microbiology 1995, 26 (2), 231-243.
(78) Nissen, H.; Alvseike, O.; Bredholt, S.; Holck, A.; Nesbakken, T., Comparison between the growth of Yersinia enterocolitica, Listeria monocytogenes, Escherichia coli O157: H7 and Salmonella spp. in ground beef packed by three commercially used packaging techniques. International journal of food microbiology 2000, 59 (3), 211-220.
(79) Ismail, H.; Lee, E.; Ko, K.; Ahn, D., Effects of aging time and natural antioxidants on the color, lipid oxidation and volatiles of irradiated ground beef. Meat Sci. 2008, 80 (3), 582-591.
(80) Rivas-Cañedo, A.; Juez-Ojeda, C.; Nunez, M.; Fernández-Garcia, E., Volatile compounds in ground beef subjected to high pressure processing: A comparison of dynamic headspace and solid-phase microextraction. Food chemistry 2011, 124 (3), 1201-1207.
(81) Migita, K.; Iiduka, T.; Tsukamoto, K.; Sugiura, S.; Tanaka, G.; Sakamaki, G.; Yamamoto, Y.; Takeshige, Y.; Miyazawa, T.; Kojima, A., Retort beef aroma that gives preferable properties to canned beef products and its aroma components. Animal Science Journal 2017, 88 (12), 2050-2056.
(82) Ismail, H.; Lee, E.; Ko, K.; Ahn, D., Effects of aging time and natural antioxidants on the color, lipid oxidation and volatiles of irradiated ground beef. Meat Science 2008, 80 (3), 582-591.
(83) Jayalekshmy, A.; Narayanan, C.; Mathew, A., Identification of volatile flavor compounds in roasted coconut. Journal of the American Oil Chemists' Society 1991, 68 (11), 873-880.
(84) Fang, M.; Cadwallader, K. R., Convenient synthesis of stable deuterium-labeled alkylpyrazines for use in stable isotope dilution assays. Journal of agricultural and food chemistry 2013, 61 (15), 3580-3588.
(85) Franklin, L. M.; Chapman, D. M.; King, E. S.; Mau, M.; Huang, G.; Mitchell, A. E., Chemical and sensory characterization of oxidative changes in roasted almonds undergoing accelerated shelf life. Journal of agricultural and food chemistry 2017, 65 (12), 2549-2563.
(86) Su, X.; Tortorice, M.; Ryo, S.; Li, X.; Waterman, K.; Hagen, A.; Yin, Y., Sensory Lexicons and Formation Pathways of Off-Aromas in Dairy Ingredients: A Review. Molecules 2020, 25 (3), 569.
(87) Lee, C. Y. and Hupp, J. T., 2010. Dye sensitized solar cells: TiO2 sensitization with a bodipy-porphyrin antenna system. Langmuir, 26(5), pp. 3760-3765.
(88) Bodaghi, H., Mostofi, Y., Oromiehie, A., Zamani, Z., Ghanbarzadeh, B., Costa, C., Conte, A. and Del Nobile, M. A., 2013. Evaluation of the photocatalytic antimicrobial effects of a TiO2 nanocomposite food packaging film by in vitro and in vivo tests. LWT-Food Science and Technology, 50(2), pp. 702-706.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure. It is intended that the specification and examples be considered as exemplary only, with a true scope and spirit of the disclosure being indicated by the following claims.

1. A food packaging composition comprising a thermoplastic polymer and an effective amount of a coordination complex comprising TiO₂ and a dye which absorbs light in the electromagnetic spectrum from about 100 nm to about 1500 nm.

2. The food packaging composition according to claim 1, wherein the dye is a compound of formula (I) 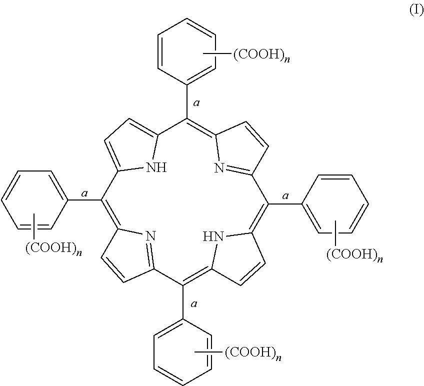
or a salt thereof, wherein n is 1 or 2, and a is a bond.

3. The food packaging composition of claim 2, wherein n is 1 and each COOH group is para to bond a.

4. The food packaging composition of claim 2, wherein n is 2 and each COOH group is meta to bond a.

5. The food packaging composition of claim 1, wherein the dye is a metal complex of TcPP (tetrakis(4-carboxyphenyl)porphyrin]) selected from the group consisting of Cu—TcPP, Zn—TcPP, Fe—TcPP, and Ni—TcPP.

6. The food packaging composition of claim 1, wherein the dye is a compound selected from the group consisting of carminic acid, erythrosine, litholrubin BK, tartrazine, and a metal complex of chlorophyllin, N3 ruthenium dye, methylene blue, Rose Bengal, Sunset Yellow FCF, Brilliant Blue FCF, Indigo Carmine, Quinoline Yellow, Patent Blue V, Allura Red AC, Carmoisine (Red 10), Ponceau 4R (Red 18), and Fast Green FCF (Green 3)

7. The food packaging composition of claim 1, wherein the coordination complex comprises the TiO₂ having one or more of the dye adsorbed on a surface of the TiO₂.

8. (canceled)

9. The food packaging composition of claim 1, wherein the coordination complex comprises a plurality of the dye covalently associated with a surface of the TiO₂ through a dative bond.

10. (canceled)

11. The food packaging composition of claim 9, wherein each dye in the plurality of dye comprises an anchoring group selected from the group consisting of carboxylic acids, thiols, and silanes; and
wherein the reactive anchoring group forms a dative bond with the surface of the TiO₂.

12. The food packaging composition of claim 1, wherein a w/w ratio of TiO₂ to the dye is from 50:1 to 1:5.

13. (canceled)

14. The food packaging composition of claim 1, wherein the dye is present in an amount from about 0.1 g per kg (g/kg) to about 300 g/kg. based on a total weight of the food packaging composition.

15. (canceled)

16. The food packaging composition of claim 1, wherein the effective amount of the coordination complex is effective to reduce a population of a microorganism by from about 1 to about 6 log CFU units after the coordination complex is subjected to a visible light for from 4 hours per day to about 24 hours per day for a period of at least 14 days.

17. The food packaging composition of claim 11, wherein the microorganism is a spoilage microorganism; and/or
wherein the microorganism is a pathogenic microorganism.

18. (canceled)

19. The food packaging composition of claim 11 wherein the effective amount of the coordination complex is at least 25% more effective than the otherwise same composition except without one or both of the dye and the TiO₂ when exposed to the same conditions.

20. (canceled)

21. The food packaging composition of claim 1, wherein the thermoplastic polymer is selected from the group consisting of a polyethylene, a high-density polyethylene, a low-density polyethylene, a polyethylene terephthalate, a polypropylene, a polystyrene, a polyester, a polyamide, a polycarbonate, a copolymer thereof, and a blend thereof.

22. The food packaging composition of claim 1, wherein the thermoplastic polymer is selected from the group consisting of a cellulose, a cellulose derivative, a starch, a starch derivative, a lignin, a lignin derivative, a gelatin, a zein, an alginate, a pullulan, a polylactide, a polybutylene adipate terephthalate, a polycaprolactone, a polyhydroxyalkanoate, a polybutylene succinate, a copolymer thereof, and a blend thereof.

23. The food packaging composition of claim 1, wherein the food packaging composition is effective to extend a shelf life of a food product by from about 10% to about 500% when compared to a shelf life of the otherwise same packaged food product except without the coordination complex when exposed to the same conditions.

24. (canceled)

25. The food packaging composition of claim 1, wherein the packaging is effective to prevent food spoilage for a time of from 10% to 500% of a spoilage time of the otherwise same food product except without the coordination complex when exposed to the same conditions.

26. (canceled)

27. A food packaging container comprising the food packaging composition according to claim 1.

28. (canceled)

29. (canceled)

30. (canceled)

31. (canceled)

32. (canceled)

33. (canceled)

34. (canceled)

35. (canceled)

36. (canceled)

37. (canceled)

38. A method of preventing food spoilage and/or increasing a shelf life in a food product in need thereof, the method comprising:
(a) contacting the food product with a composition of claim 1; and
(b) exposing the composition or packaging container to light having a wavelength of from about 100 nm to about 1500 nm.

39. (canceled)

40. (canceled)

41. (canceled)

42. (canceled)
